(19) United States
(12) Patent Application Publication
(10) Pub. No.: US 2002/0171726 A1
(43) Pub. Date: Nov. 21, 2002

(54) Image recording apparatus

(76) Inventors: Yoshio Ishii, Kanagawa (JP); Osamu Takahashi, Kanagawa (JP); Eiichi Kito, Kanagawa (JP)

Correspondence Address: YOUNG & THOMPSON, 745 SOUTH 23RD STREET 2ND FLOOR, ARLINGTON, VA, 22202

(21) Appl. No.: 10/131,463

(22) Filed: Apr. 25, 2002

(30) Foreign Application Priority Data
Apr. 25, 2001 (JP) 2001-127176

(51) Int. Cl. B41J 2/01

(52) U.S. Cl. 347/101; 347/154

(57) ABSTRACT

An image recording apparatus which draws a recording material from a roll to an image recording station along a longitudinal direction of the recording material. A recording head is gradually moved (sub-scanning) along a widthwise direction of the recording material while reciprocating (main scanning) along the longitudinal direction of the recording material. Recording liquid drops are discharged from nozzles of the recording head and adhere to the recording material, thereby concurrently recording a plurality of images along the longitudinal direction of the recording material. A portion of the recording material where the plurality of images are recorded is cut and separated by a first cutter, and this portion is conveyed along the longitudinal direction. Solvent included in the adhered recording liquid drops is removed, and a transparent film is formed. The recording material is then cut by a second cutter into individual images.

### BACKGROUND OF THE INVENTION

1. Field of the Invention

The present invention relates to an image recording apparatus, and more particularly to an image recording apparatus in which drops of recording liquid discharged from discharge ports of one or more recording heads are caused to adhere to a long recording material, thereby recording a plurality of images along a longitudinal direction of the recording material, and the recording material is cut into portions that each correspond to one of the individual images.

2. Description of the Related Art

The most common method for shooting a subject and recording a color image on a recording material such as paper is a method using a silver halide color photosensitive material. The image recording method using the silver halide color photosensitive material has the merit that a large number of images can be recorded at high speed, but there is also the problem that the apparatus is large in size and complicated in structure, and maintenance thereof is troublesome. Various improvements have previously been made to decrease the size of the apparatus and to reduce the need for maintenance, further reductions in size and maintenance requirements are desired.

Alternately another image recording method widely used for recording data output from a computer onto a recording material as an image is an ink-jet recording system in which ink drops discharged from discharge ports of a recording head are caused to adhere to a recording material, thereby recording the image on the recording material. Since the ink-jet recording system records an image by causing a coloring solution (ink) to adhere directly to the recording material, there is a merit in that variations in image density caused by variations in environmental conditions, such as temperature, are small. This is basically advantageous in terms of maintenance as compared with the image recording method using the silver halide color photosensitive material.

As one example of an apparatus for recording images at high speed using the ink-jet recording system, Japanese Patent Application Laid-open (JP-A) No. 2000-127550 discloses a structure in which a wide recording material wound into a roll is drawn from the roll and conveyed along a first direction which is parallel to the direction in which it is drawn from the roll. A plurality of images is recorded along a widthwise direction of the recording material, and then the image-recorded portion of the recording material is separated (cut) from a black portion and is conveyed along a second direction perpendicular to the first direction (and parallel to the direction in which the plurality of images is aligned). The image-recorded portion is then cut into portions corresponding to individual images.

In the image recording apparatus of the above publication, however, since a wide recording material is used for recording the plurality of images along the widthwise direction thereof, the size of mechanisms for conveying the recording material is increased, and it is also necessary to use a large cutter to cut the recording material along the widthwise direction thereof. There is a disadvantage, therefore, in that the image recording apparatus is increased in size. Further, since the size of the roll is also increased, it is necessary to provide space around the apparatus for loading the roll of the recording material into the apparatus, and the floor area required for installing the apparatus is extremely large.

Moreover, in the image recording apparatus described in the above publication, the plurality of images is concurrently recorded along the widthwise direction of the recording material, and then the separated image-recorded portion is conveyed in a direction which is different from the former conveyance direction by 90°. Therefore, there are problems in that a plurality of conveying mechanisms whose conveyance directions are different by 90° must be provided, and it is also necessary to provide a handover mechanism for conveying the recording material between the respective conveying mechanisms, which mechanism is complicated, and maintenance thereof is troublesome.

Further, in the ink-jet recording system, abnormal conditions, such as discharge failure of ink drops caused by clogging of the discharge ports of the recording head, occur in some cases, and there is a problem in that if the abnormal conditions, an easily visible critical defect, such as a white stripe, is generated in the image. This problem is a serious defect especially when a large number of images are continuously recorded on the recording material. When the defect is found after a large number of images have been recorded, the processing capacity (the number of images recorded per unit of time) and the yield of outputted images of appropriate image quality are greatly lowered since all of the images must be recorded again. The image recording apparatus described in the above publication, however, does not take this point into account.

### SUMMARY OF THE INVENTION

The present invention has been accomplished in view of the abovementioned facts, and it is an object of the invention to provide an image recording apparatus capable of recording a large number of images at high speed, while reducing the space which is required for installing the apparatus.

To achieve the object stated above, a first aspect of the present invention provides an image recording apparatus for use with an elongated recording material, the apparatus comprising: conveying means for conveying the recording material along a conveyance path in the longitudinal direction of the recording material; recording means disposed on the conveyance path for concurrently recording a plurality of images onto the recording material, the images being arranged in the longitudinal direction of the recording material, the recording means including at least one recording head which includes a discharge port, drops of recording liquid being discharged from the discharge port and adhering to the recording material; first cutting means disposed on the conveyance path for cutting the recording material into portions that each correspond to the plurality of images; and second cutting means disposed on the conveyance path downstream from the first cutting means for cutting the portions that each correspond to the plurality of images into portions that each correspond to one of the images.

In the first aspect of the present invention, the conveyance path for conveying the long recording material in the longitudinal direction thereof is provided, and the recording material is conveyed along the conveyance path by the conveying means. The recording means causes the drops of recording liquid discharged from the discharge port of the recording head to adhere to the portion of the recording material located at image recording position on the conveyance path, thereby recording the plurality of images concurrently along the longitudinal direction of the recording material. The recording material is cut into the portions that each correspond to the plurality of concurrently recorded images by the first cutting means any of before the images are recorded, while the images are being recorded, or after the images have been recorded. Since the plurality of images is recorded along the longitudinal direction of the recording material, it is unnecessary to use a wide recording material, which would allow recording of plurality of images along the widthwise direction thereof, and it is possible to reduce the space occupied by the conveying means (and the conveyance path), which conveys the recording material. Since the plurality of images is concurrently recorded by the recording material, it is possible to shorten the recording time per image as compared with a case in which a plurality of images are sequentially recorded.

In this manner, according to the first aspect of the invention, it is possible to shorten the recording time per image, and a large number of images can be recorded at high speed. At the same time it is possible to reduce the width of the recording material, the recording of the images onto the recording material, the cutting of the recording material into the portions that each correspond to the plurality of images, and the cutting of the recording material into portions that each correspond to one of the images can be sequentially carried out while the recording material is conveyed along the conveyance path in the longitudinal direction of the recording material. Thus, it is unnecessary to provide a plurality of conveying mechanisms whose conveyance directions of the recording material are different by 90° or a handover mechanism which conveys the recording material between the conveying mechanisms, and it is possible to reduce the amount of space required for installing the image recording apparatus.

It is preferable that the conveyance path comprises a first conveyance path for conveying the recording material substantially vertically and a second conveyance path for conveying the recording material in a direction which is substantially vertical and opposite from the direction of the first conveyance path and that the first and second conveyance paths are connected to each other through a conveyance retroversion path which retroverts the conveyance direction. With this structure, the image recording apparatus of the present invention can be made long in the vertical direction, and the amount of space, especially floor area, required for installing the apparatus can be greatly reduced.

The recording material is previously wound into a roll, and the conveying means may draw the recording material from the roll and convey the same. When the recording material is previously wound into the roll, the operability of the recording material when it is loaded into the image recording apparatus is enhanced as compared with a case in which the recording material is previously cut to a predetermined size.

As the recording means, it is possible to employ a structure in which the recording head is moved along a predetermined main scanning direction and a sub-scanning direction perpendicular to the main scanning direction with respect to the recording regions of the plurality of images on the recording material located the image recording position on the conveyance path, thereby recording the plurality of images concurrently. In this case, a single recording head records the plurality of images concurrently.

In the present invention, since the plurality of images are recorded along the longitudinal direction of the recording material, the recording regions of the plurality of images are rectangular, and it is preferable that the main scanning direction coincides or substantially coincides with a lengthwise direction of the rectangular recording regions. The recording head is gradually moved along the sub-scanning direction while being reciprocated in the main scanning direction. In addition to the time used actually recording the images, time is also required for the recording head to decelerate, come to a stop, and accelerate to a predetermined speed in the opposite direction for each reciprocating motion. Thus, if the main scanning direction coincides or substantially coincides with the lengthwise direction of the rectangular recording regions, the number of reciprocating motions of the recording head when the plurality of images are recorded in the plurality of image recording regions is reduced, and it is possible to shorten the recording time per image.

Various structures may be employed as the recording means. For example, recording heads may be disposed at a plurality of different positions along the longitudinal direction of the recording material (in this case, the number of recording heads need not be the same as the number of images to be recorded concurrently), and the recording liquid drops may be concurrently discharged from the discharge ports of each recording head, thereby recording the plurality of images concurrently. A second aspect of the present invention provides an image recording apparatus for use with an elongated recording material, the apparatus comprising: conveying means for conveying the recording material along a conveyance path in the longitudinal direction of the recording material; recording means disposed on the conveyance path for concurrently recording a plurality of images onto the recording material, the images being arranged in the longitudinal direction of the recording material, the recording means including a plurality of recording heads which include discharge ports, drops of recording liquid being discharged from the discharge ports and adhering to the recording material; and cutting means disposed on the conveyance path downstream from the recording means for cutting the recording material into portions that each correspond to one of the images.

In the second aspect of the present invention, the conveyance path for conveying the long recording material in the longitudinal direction thereof is provided, and the recording material is conveyed along the conveyance path by the conveying means. The recording means includes a plurality of recording heads disposed at different positions on the conveyance path along the conveyance direction of the recording material, and the drops of recording liquid are discharged from the discharge ports of the recording heads. The discharged drops of recording liquid are caused to adhere to the recording material, and the plurality of recording heads concurrently records the images onto the recording material along the longitudinal direction thereof. The number of recording heads may be or not be the same as the number of the images to be concurrently recorded. The two or more images to be concurrently recorded may the same as or different from each other.

Since the two or more images are recorded along the longitudinal direction of the recording material in this manner, it is unnecessary to use a wide recording material which allows recording of a plurality of images along a widthwise direction thereof, and it is possible to reduce the space occupied by the conveying means (and the conveyance path), which conveys the recording material. As a scanning method carried by each of the recording heads, for example, it is possible to employ a method in which the recording heads are reciprocated along the widthwise direction of the recording material while the recording material is conveyed. In this aspect as well, since the recording material can be made narrow in width as described above, it is possible to shorten the moving distance of the reciprocating motion of the recording heads, and it is possible to reduce the size of the mechanism which reciprocates the recording heads.

The recording material onto which the images have been recorded by the recording means is cut by the cutting means into portions that each correspond to one of the images. The recording material is cut along the widthwise direction thereof, and since the recording material can be made narrow in width, as described above, the cutting means can also be reduced in size. Moreover, since the images are recorded onto the recording material and the recording material is cut while the recording material is conveyed along the conveyance path in the longitudinal direction of the recording material, it is unnecessary to provide a plurality of conveying mechanisms whose conveyance directions of the recording material are different by 90° and a handover mechanism which conveys the recording material between such conveying mechanisms. Further, since the recording means concurrently records two or more images by the plurality of recording heads, it is possible to shorten the recording time per image as compared with a case in which the plurality of images is sequentially recorded. Thus, it is possible to obtain a compact image recording apparatus capable of recording a large number of images at high speed.

In the second aspect of the present invention, as the recording means, it is possible to employ a structure in which the recording means includes moving means which reciprocates each of the recording heads along a widthwise direction of the recording material, each of the recording heads is reciprocated by the moving means while the recording material is conveyed by the conveying means, and the drops of recording liquid are discharged from each of the recording heads, thereby recording two or more images concurrently onto the recording material. In this case, although the structure of the apparatus is slightly complicated since the moving means is provided, maintenance of the recording heads is facilitated as compared with a case in which a recording head provided with a large number of discharge ports is used.

Each of the recording heads may include a large number of discharge ports continuously arranged from one end of the recording material to the other in the widthwise direction thereof, and the recording means may cause the drops of recording liquid to be discharged from each of the recording heads while the recording material is conveyed by the conveying means. With this structure, it is possible to record two or more images onto the recording material concurrently. In this case, maintenance of the recording heads becomes complicated, but since the moving means can be omitted and it is unnecessary to control the reciprocating motion of the recording heads, the structure of the apparatus can be simplified.

In the second aspect of the present invention, the cutting means may include first cutting means which cuts the recording material conveyed on the conveyance path into portions that each correspond to the plurality of concurrently recorded images before the images are recorded, while the images are being recorded, or after the images have been recorded; and second cutting means disposed on the conveyance path which further cuts the portions that each correspond to the plurality of images into portions that each correspond to one of the images.

In the first and second aspects of the present invention, since the recording means records the images in multiple-image units that each correspond to the plurality of images, the recording material onto which the images have been recorded is intermittently outputted (discharged) in multiple-image portions that each correspond to the plurality of images. Thus, the recording material may be cut into the portions that each correspond to the plurality of images by the first cutting means before the images are recorded, while the images are being recorded, or after the images have been recorded.

Thus, the recording material onto which the images are recorded can be continuously conveyed on the conveyance path downstream from the image recording position of the recording means and the cutting position of the first cutting means in the portions that each correspond to the plurality of concurrently recorded images. Even when the postprocessing (which will be described in detail later) is carried out for the recording material onto which images were recorded, said post-processing can be carried out without any ill effects resulting from the fact that the recording means records the images in the multiple-image units.

Then, the recording material (onto which the images have been recorded by the recording means and which has been cut into the multiple-image portions by the first cutting means and conveyed on the conveyance path by the conveying means), which has been conveyed to the cutting position of the second cutting means, is cut into portions that each correspond to one of the individual images by the second cutting means.

The drops of recording liquid may be discharged from the discharge ports of each of the one or more recording heads based on image data of the plurality of images to be concurrently recorded, which has been obtained by reading a corresponding plurality of original images (e.g., original images recorded onto photographic film) by reading means.

In the first and second aspects of the present invention, the images are recorded by the recording means, the recording material is cut by the first cutting means into portions that each correspond to the plurality of concurrently recorded images, and post-processing means may be provided for carrying out predetermined post-processing of the recording material which is conveyed on the conveyance path by the conveying means, before the recording material is cut by the second cutting means into portions that each correspond to one of the individual images. The predetermined post-processing carried out by the post-processing means may form a transparent film or remove solvent, for example. By carrying out such predetermined post-processing before the recording material is cut by the second cutting means, it is possible to easily stabilize the conveyance of the recording material as compared with a case in which the recording material is cut into portions that each correspond to one of the individual images subjected to the predetermined post-processing, and it is also possible to suppress variation in the results of the predetermined post-processing among the individual images.

The post-processing means may form the transparent film on the image recording surface of the recording material as the predetermined post-processing. This processing enhances the waterproofinging and weather resistance of the images recorded onto the recording material.

In the case that the transparent film is formed on the image recording surface of the recording material, if the solvent included in the drops of recording liquid adhered to the recording material remains on the recording material when the transparent film is formed, there is an adverse possibility that the remaining solvent may be trapped under the transparent film, and the trapped solvent will lower the image quality of the recorded images. Therefore, it is preferable that the post-processing means applies thermal energy to the recording material to which the drops of recording liquid have been caused to adhere by the recording means, thereby removing the solvent included in the drops of recording liquid. Thus, since the solvent included in the drops of recording liquid adhered to the recording material is removed within a short time, it is possible to prevent the image quality of the recorded images from being deteriorated by the solvent remaining on the recording material.

The first and second aspects of the present invention may further comprise monitoring means for monitoring for occurrence of events that may hinder image recording by the recording means while the recording means records the images onto the recording material, and processing means for, when the monitoring means has detected that one or more of the events has occurred, processing to overcome the events.

Examples of the events that may hinder the image recording are failure of the recording means (specifically, clogging of one or more of the discharge ports of the recording heads, reduction in discharge amount of the drops of recording liquid, etc.) and reduction in the spare capacity of a storing means which stores the image information.

The first and second aspects of the present invention may further comprise obtaining means for obtaining original image information expressing the original images to be recorded onto the recording material, and image processing means for carrying out image processing of the original image information obtained by the obtaining means, thereby generating image information expressing the images to be recorded onto the recording material, and for outputting the generated image information to the recording means. Additional events which may hinder image recording in this structure are, for example, failure of the obtaining means, obtaining of defective original image information by the obtaining means, and image processing failure by the image processing means.

When one or more of the events has occurred while the recording means continuously records the plurality of images onto the recording material, this is detected by the monitoring means, and the hindrance to image recording or event which may become a hindrance itself is overcome. Therefore, it is possible to prevent a large number of images of improper image quality from being recorded after the event has occurred and to prevent the image recording operation from being discontinued for a long time due to the event, and it is possible to realize enhanced yield of appropriate images and improved capability of the image recording apparatus of the present invention.

In the second aspect of the present invention, when it has been determined by the monitoring means that the event which may hinder the image recording is clogging of one or more of the discharge ports of a certain recording head, the processing means continues recording the images using only the recording heads whose discharge ports are not clogged to overcome the event.

In most cases, the clogging of the discharge ports of the recording heads can automatically be overcome by applying suction to the ink in the recording head via a pump, but the clogging may be not overcome by actuating the pump in some cases. In the later case, it would be necessary to discontinue recording the images onto the recording material until an operator overcomes the clogging of the discharge ports. According to the second aspect of the present invention, however, the image recording can be continued using only the recording heads whose discharge ports are not clogged, utilizing the fact that the plurality of recording heads are provided in the image recording apparatus. Therefore, although the number of images recorded per unit of time is reduced, the recording of images onto the recording material can be continued even if clogging which is difficult to overcome occurs in the discharge ports of the recording head.

### BRIEF DESCRIPTION OF THE DRAWINGS

FIG. 1 is a block diagram showing an outline structure of an image recording system according to an embodiment of the present invention.

FIG. 2 is a schematic structural diagram showing an outline structure of an ink-jet printer of the embodiment of the present invention.

FIG. 3 is a perspective view showing one example of an image recording mechanism.

FIG. 4 is a schematic view showing an ink supply mechanism for a recording head.

FIG. 5 is a schematic diagram explaining image recording and cutting of a recording material in the ink-jet printer.

FIG. 6 is a schematic structural diagram showing another example of an outline structure of the ink-jet printer of the embodiment of the present invention.

FIG. 7 is a block diagram showing an outline structure of an image recording system according to a second embodiment of the present invention.

FIG. 8 is a schematic structural diagram showing an outline structure of an ink-jet printer of the second embodiment of the present invention.

FIG. 9 is a perspective view showing another example of an image recording mechanism.

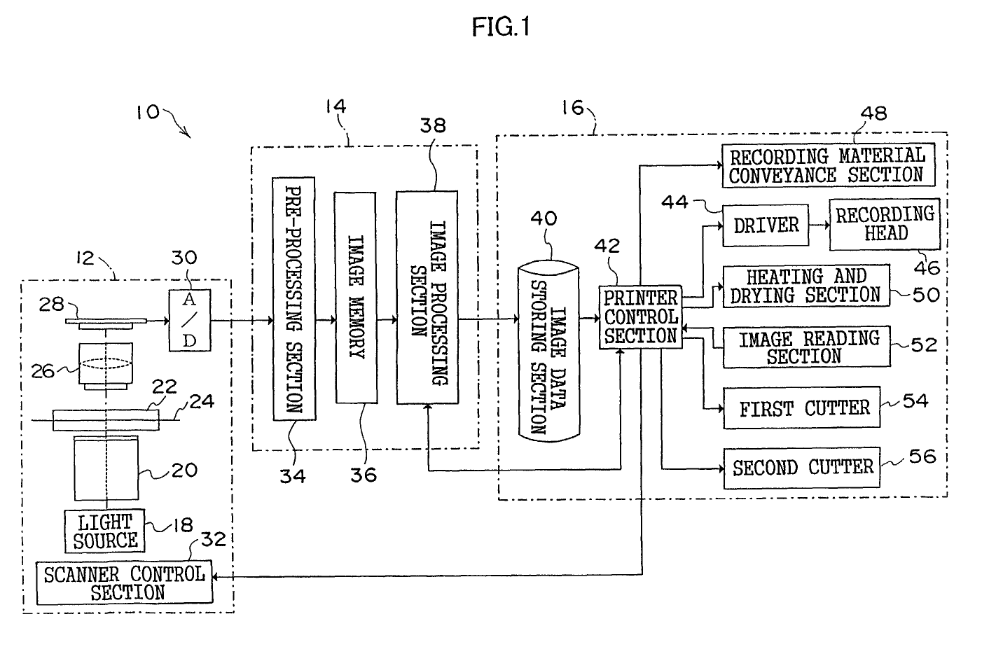

FIGS. 1OA to 1OF are schematic diagrams explaining the sequence of image recording and cutting of a recording material in the ink-jet printer of the second embodiment of the present invention.

FIG. 11 is a perspective view showing yet another example of an image recording mechanism.

### DESCRIPTION OF THE PREFERRED EMBODIMENTS

A first embodiment of the present invention will be explained in detail with reference to the drawings. FIG. 1 shows an outline structure of an image recording system 10 to which the present invention is applied. The image recording system 10 includes a film scanner 12 as an input apparatus for inputting image data, an image processing apparatus 14 for processing the image data input from the input apparatus, and an ink-jet printer 16 as an output apparatus which outputs the image expressed by the image data which has been subjected to processing by the image processing apparatus 14. The ink-jet printer 16 records the image via an ink-jet recording system.

The film scanner 12 reads a film image (a negative image or a positive image which has been visualized via developing after shooting a subject) recorded on a photographic photosensitive material (hereinafter, photographic film) such as photographic film 24 (e.g., negative film or reversal film), and the film scanner 12 outputs image data obtained by reading the film image. The film scanner 12 includes a film carrier 22 in which the photographic film 24 is set and irradiated with light which is emitted from an LED light source 18 and whose variation in light quantity is reduced by a light diffusion box 20. The light passing through the photographic film 24 then forms an image on a light-receiving surface of an area CCD sensor 28 (it may alternately be a line CCD sensor) through a lens 26.

The film carrier 22 intermittently conveys the photographic film 24 such that each film image is placed in turn on an optical axis (reading position) of the light emitted from the LED light source 18. The LED light source 18 comprises a large number of LEDs emitting red (R) light, a large number of LEDs emitting green (G) light, a large number of LED emitting blue (B) light, and a large number of LED emitting infrared (IR) light, which are arranged with constant and high density on an entire surface of a substrate (not shown). The LED light source 18 is driven by a driver (not shown) such that the R, G and B light is emitted in order while a single image is located at the reading position.

Thus, the film images recorded on the photographic film 24 are sequentially read by the CCD sensor 28, and R, G, B and IR signals corresponding to the film image are outputted from the CCD sensor 28. The signals outputted from the CCD sensor 28 are converted into digital image data by an A/D converter 30, and inputted to the image processing apparatus 14. The film scanner 12 is provided with a scanner control section 32, which controls the operation of each portion of the film scanner

FIG. 12. The reading operation may be carried out a plurality of times (e.g., a pre-scan for reading a film image at relatively low resolution, and a fine scan for reading the film image at relatively high resolution) for each of the film images.

As the input apparatus of the present embodiment, a reflection type scanner, which photoelectrically converts light reflected from a reflection type original copy (e.g., paper on which a color image is recorded) and outputs the image data obtained by reading the original document may be provided in addition to the film scanner 12. For this reflection type scanner, it is preferable to use a scanner provided with an auto-feeder which automatically feeds a plurality of the reflection type original document to a reading section of the scanner so that the original document can be read automatically and continuously.

As the input apparatus of the present embodiment, it is possible to provide an image data receiving apparatus which receives R, G, and B image data from a media driver or an information processing apparatus and outputs the received image data. In the former case, the media driver reads image data stored in an information storage medium (e.g., a magnetic disk, such as a floppy disk (FD); an optical disc, such as a CD-R; a magnetooptical disc; or an information storage medium which can be loaded to a digital still camera, such as a SMART MEDIA®, a COMPACT FLASH®, a memory stick or the like) and outputs the same. In the latter case the image data receiving apparatus is connected to a computer network, such as the Internet, and receives the image data from the information processing apparatus (e.g., a personal computer) via the computer network.

The film scanner 12 is connected to a pre-processing section 34 of the image processing apparatus 14. The film scanner 12 carries out predetermined pre-processing, such as darkness correction, density conversion, shading correction, defective pixel correction and the like, on the image date input from the film scanner 12. When a media driver is provided, examples of the pre-processing for image data input from the media driver include decompressing image data compressed and recorded in an information storing medium, and image processing to enhance sharpness. When an image data receiving apparatus is provided, examples of the pre-processing for the image date input from the image data receiving apparatus include decompressing compressed image data (JPEG image data, for example) received by the image data receiving apparatus. The pre-processing section 34 is connected to the image processing section 38 via an image memory 36. The image data subjected to the pre-processing by the pre-processing section 34 is temporarily stored in the image memory 36, and then, read by and input to the image processing section 38. Based on the image data read by the image memory 36, the image processing section 38 automatically determines processing conditions of various image processings for the image data (setup computation).

Examples of image processing executed by the image processing section 38 are gray balance adjustment of the image, density adjustment, gray control, hypertone processing for compressing gradation of very low frequency brightness component, hypersharpness processing for emphasizing sharpness while suppressing graininess, and defect portion correcting processing for correcting defective portions of the image data due to damage or foreign matter adhered to the photographic film.

The image processing section 38 carries out various image processings on the image data read from the image memory 36 in accordance with the processing conditions determined by the setup computation. The image processing section 38 is connected to an image data storing section 40 of the ink-jet printer 16. Image data which has been subjected to the various image processings is conveyed to the image data storing section 40 as recording image data and temporarily stored.

A printer control section 42 is connected to the image data storing section 40 of the ink-jet printer 16. The printer control section 42 is connected to the scanner control section 32 of the film scanner 12 and the image processing section 38 of the image processing apparatus 14. A recording head 46 (details thereof will be described later) is connected to the printer control section 42 via a driver 44. A recording material conveyance section 48, a heating and drying section 50, an image reading section 52, a first cutter 54 and a second cutter 56 are also connected to the printer control section 42.

The recording material conveyance section 48 corresponds to conveying means of the invention, and includes a drawing and conveying motor, a conveyance retroversion motor, a downward conveyance motor, a pair of pull-out rollers 66, and pairs of conveying rollers 68, 70, 71, 74, 76, 78, 82, 84, 86, 88 and 90. The first cutter 54 corresponds to first cutting means and the second cutter 56 corresponds to second cutting means of the invention.

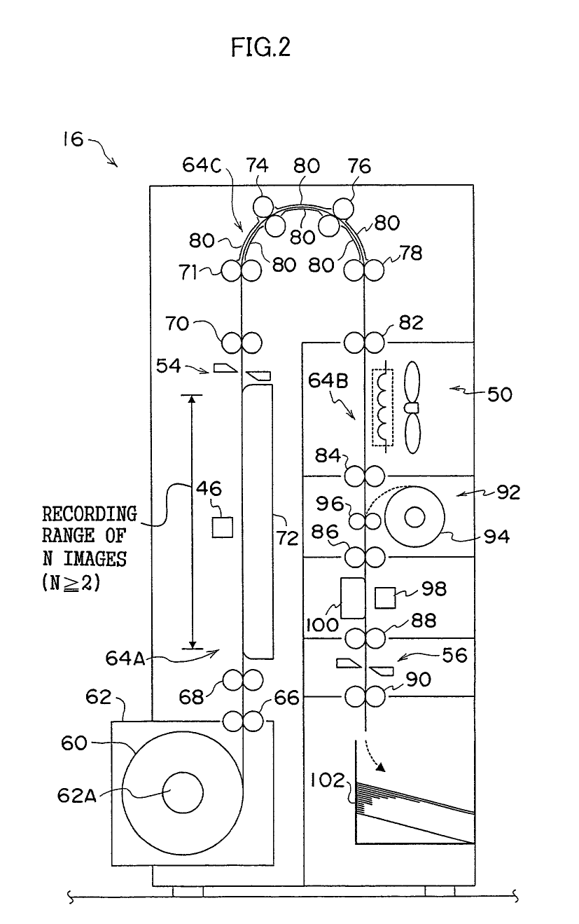

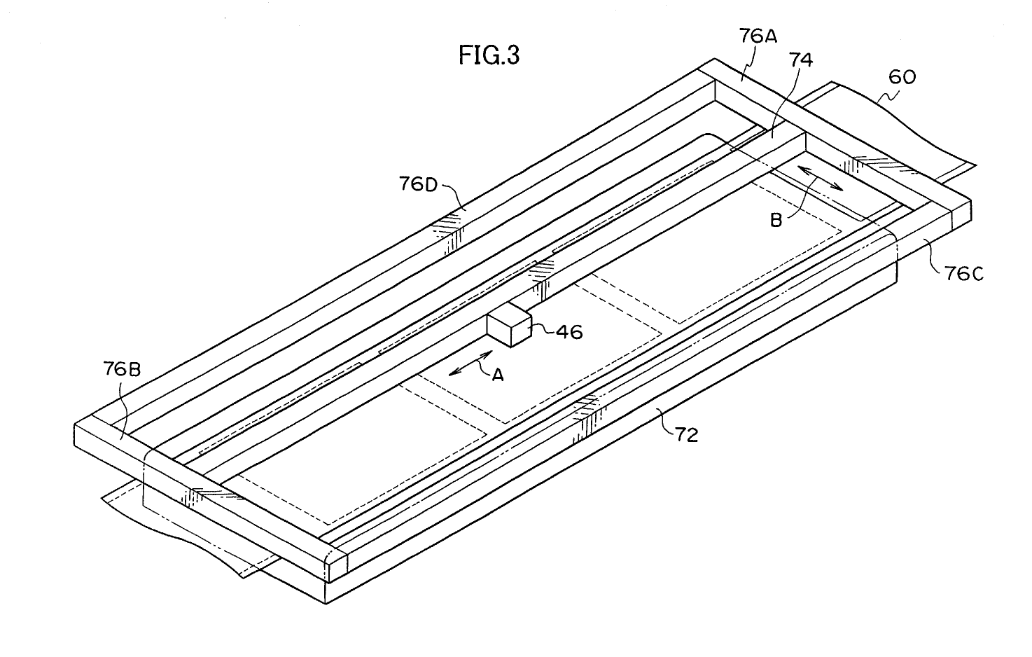

As shown in FIG. 2, a cabinet 16A of the ink-jet printer 16 is formed in a vertically long, substantially box-like shape. A magazine 62 for accommodating a recording material 60 is set at the side and near a lower end of the cabinet 16A. The recording material 60 is formed into a long sheet, and is supplied in the form of a roll wound around an outer periphery of a roll core 62A such that a surface on a side of the recording material 60 where an ink receiving layer is formed (image recording surface) faces inside. The recording material 60 is loaded in a magazine 62 and then, when the recording material 60 is to be used for recording images, the magazine 62 is thus set to the cabinet 16A, and the recording material 60 is set in a predetermined position (the position shown in FIG. 2).

In the present embodiment, the following recording materials can be used as the recording material 60. That is, as a support for the recording material 60, any of transparent or opaque base materials can be used. Advantageous examples of supports include supports used for papers such as bond paper, art paper, resin-coated paper, and baryta paper; films of polyethylene terephthalate, triacetate, polycarbonate, polyacrylate, and copolymers thereof; and especially, silver halide color photosensitive materials. A sheet of paper having ink absorbency or a porous resin film can be coated with a thermoplastic resin to enhance waterproofing and airproofing. To obtain a recorded material having quality as high as a silver halide color photosensitive material, it is preferable to use a support having high brightness, smoothness and preservability, such as current baryta papers, WP papers and the like. It is preferable that the smoothness is 20 seconds or more, as measured by a method described in surface Beck smoothness JIS-P-8119, and that tensile strength is 2 to 30 kg, as measured by a method described in JIS-P-8113.

The ink receiving layer is a layer having the functions of absorbing ink discharged by ink jets with little spreading, absorbing dye and holding an image. To obtain an image which strongly absorbs water, absorbs and fixes an image forming dye on a specific layer, and reduces spreading or beading, it is preferable to form a multi-layered structure by providing a spongy layer close to the support and a plurality of layers for absorbing and fixing the dye. An inorganic pigment which absorbs dye and a surfaceactive agent for a binder which has high ink permeability and which does not hinder dye absorption are used. Further, it is preferable to use a thermoplastic resin latex which will protect the image.

As the inorganic pigment which absorbs dye, known materials such as silica, calcium carbonate, calcium sulfate, diatomite, calcium silicate, colloid silica, alumina, pseudo boehmite, colloid alumina, alumina hydrate and the like are used. Especially, alumina hydrate, silica, colloid silica and the like are preferable. The pigment is provided at gaps in the layer.

Alumina hydrate can be produced by a known method such as hydrolytic degradation of aluminum alkoxide, hydrolytic degradation of sodium aluminate and the like. A shape of the alumina hydrate may be but is not limited to cilia shape, needle shape, plate shape, spindle shape or the like, and the same may not be orientated.

The alumina hydrate used in the invention can be, one which is available industrially, or one processed from raw material, and a more preferable alumina hydrate is one having high transparency, high glossiness, high dye-fixing ability, and high coating ability so as to not crack when a film thereof is formed. Examples of industrially available alumina hydrate include AS-2 and, AS-3 from Catalysts & Chemicals Ind. Co., Ltd.,and 520 of Nissan Chemical Industries, Ltd.

Grain sizes of these alumina hydrates are normally as little as 1 μm or less, and the alumina hydrates have excellent dispersibility. Thus, the recording material 60 can have extremely excellent smoothness and glossiness.

It is preferable that a coating amount of an inorganic pigment, especially an alumina hydrate, onto a base material is 10 g/m² or more so as to obtain the dye-fixing property. The coating amount when the base material does not have ink absorbency is preferably in a range of 30 to 50 g/m², and the coating amount when the base material has ink absorbency is preferably in a range of 20 to 40 g/m².

Coating and drying methods are not especially limited, and the alumina hydrate and binder can be subjected to sintering if necessary. If they are sintered, cross-linking strength of the binder is enhanced, the mechanical strength of the ink receiving layer is enhanced, and surface glossiness of the alumina hydrate layer is enhanced.

The binder for binding the inorganic pigment can be freely selected from water-soluble high polymers. Preferable examples of the binder are polyvinyl alcohol or a denatured form thereof, starch or a denatured form thereof, gelatin or a denatured form thereof, casein or a denatured form thereof; cellulose derivatives such as gum arabic, carboxymethyl cellulose, hydroxyethylcellulose, and hydroxy propyl methylcellulose; conjugated diene-based copolymer latexes such as SBR latex, NBR latex, methyl methacrylate-butadiene copolymer; vinyl-based copolymer latexes such as functional group-denatured copolymer latex, ethylene-vinyl acetate copolymer; and a polyvinyl pyrrolidone/acrylic ester copolymer. The binders can be used singly or in combination.

A mixing ratio of the inorganic pigment, especially an alumina hydrate, with the binder is preferably in a range of 1:1 to 30:1, and more preferably in a range of 5:1 to 25:1. The amount of the binder is selected to be in such a range that cracks are not occurred, and powder does not fall away, etc.

As the inorganic pigment, silica or colloid silica can be formed into a porous structure like alumina and used. As the binder, a cationdenatured polyvinyl alcohol or copolymer thereof can be used, in addition to binders described in JP-A No. 61-10483.

The image protection layer is provided on the ink receiving layer, protects the physical strength of the ink receiving layer, enhances durability and weather resistance of the image and conveyability together with a back coat layer, and prevents the ink receiving layer from being damaged by bonding when the recording material is wound into a roll shape.

As the image protection layer, it is possible to provide, on the ink receiving layer containing the porous inorganic pigment, a layer comprising an ink-permeable binder including inorganic pigment grains or a resin latex. The resin latex to be used in such an amount that the ink permeability is not deteriorated, is preferably mono dispersive, and is preferably thicker than the image protection layer. For example, the resin latex may be selected and used from raw materials described in JP-A No. 11-321080.

The recording material 60 may be provided with an image protection layer as described below.

The image protection layer is formed of a porous resin using a thermoplastic resin latex, and the grain distribution of the latex is especially important. The average grain size of the resin latex is 0.1 to 10 μm, preferably 0.3 to 5 μm, and more preferably 0.3 to 3 μm. A mono dispersive distribution is preferable, i.e., a latex of uniform grain in which 90% or more grains are within in ±2/3 of the average grain size. It is especially preferable that fine grains are not included. The thermoplastic resin latex is of porous structure, solid grain content is preferably about 10 to 60 weight %, the ink permeability is not hindered, and it is preferable to select a solid amount so as to form a transparent resin film after formation of the image. It is also possible to use a plurality of thermoplastic resin latexes having different MFTs (minimum film temperature) and having high compatibility.

It is preferable that the thermoplastic resin used in the present invention is resin having characteristics such that the resin becomes nonporous after a thermal treatment, forms a film and protects the image. Especially preferable is a resin with a component having high ultraviolet absorption.

Examples of the latex include any of vinyl chloride based, vinylidene chloride based, styrene based, acrylic based, urethane based, polyester based, and ethylene based materials, or latexes such as vinyl chloride-vinyl acetate based, vinyl chloride-acrylic based, vinyl chloride based, vinylidene chloride-acrylic based, SBR based, and NBR based latexes, or a copolymer latex of two or more of the above latexes, for example, a SBR based / NBR based mixture, or a mixture of vinyl chloride-acrylic based / vinyl acetate based latexes.

Further, it is preferable that light resistance is strong, and that components including a conjugate double bond are 50% or less. A thermal treatment is preferable as a method for changing the porous layer including the thermoplastic resin into a non-porous form. Then weather resistance such as waterproofing and light resistance becomes excellent, the image has glossiness, and printed matter can be preserved for a long term.

The heating temperature at this time is equal to or higher than a flowing temperature of the thermoplastic resin grain, and is preferably equal to or higher than a minimum film-forming temperature (MFT). Although it depends on the kind of thermoplastic resin, it is preferable that the temperature is in a range of about 60 to 180° C., taking surface characteristics after film formation into account. The minimum filmforming temperature is a temperature at which the image protection layer is re-formed and becomes substantially transparent, and this also depends on process duration.

It is preferable that 10 to 30 weight % of silica sol is mixed into the image protection layer. Thus provides an effect that adhering strength with respect to the ink receiving layer is enhanced, beading and the like are prevented, and sharpness of the image is enhanced.

It is preferable that a hydrophilic binder used for the ink receiving layer, e.g., polyvinyl alcohol or the like, is also added to the image protection layer so as to optimize adhesiveness to the ink receiving layer, to enhance the sharpness of the image, and to keep the physical strength of the image protection layer.

It is preferable that an overcoat layer including raw materials selected from inorganic pigment grains, resin latexes and lubricants is provided on the image protection layer. The film thickness of the overcoat layer is preferably 0.2 to 2 μm. If the thickness is sufficiently thin, there are advantageous characteristics for the conveyability of the inorganic pigment grains or resin latex in the image protection layer.

As necessary, to coating liquids for forming the ink receiving layer and the image protection layer, a disperser, viscosity-increasing agent, pH adjusting agent, lubricant, flow-improving agent, surface-active agent, antifoaming agent, waterproofing agent, fluorescence brighter, ultraviolet absorbent, and antioxidant may be added.

A back coat layer is provided on a back surface of the ink receiving layer. By providing the back coat layer, conveyability of the recording material in the image recording process is enhanced, the ink receiving layer is substantially protected, functionality of the image protection layer is facilitated, and abnormal events in the image recording process can be reduced. After surface processing or undercoat processing of the support, it is possible to use, as a binder of the backcoat-layer one or a combination of a hydrophilic binder having high adhesiveness, e.g., gelatin or a denatured form thereof, casein or a denatured form thereof, polyvinyl alcohol or a denatured form thereof, polyvinyl pyrrolidone, polyethylene oxide, polyacrylic acid, polyacrylic acid amido, carboxymethyl cellulose, hydroxyethylcellulose, hydroxy propyl methylcellulose and the like. To enhance the adhesiveness and physical strength of the back coat layer, it may be preferable to use a hardener for the binder. For example, polyvinyl alcohol or a copolymer thereof, or a boric acid or salt of another polymer may be good. For gelatin or a denatured form thereof, a known hardener such as an epoxy based compound is used.

To enhance the conveyability of the recording material, a resin latex or a dispersion material such as an inorganic pigment or the like having, a sufficiently large grain size relative to a mat agent, i.e., to a film layer of the mat agent, is used. The average grain size thereof is larger than the dry film thickness, and is 0.5 to 30 μm, and preferably 0.5 to 10 μm. A mono dispersive material is preferable. The amount thereof preferably gives about 10 to 30 projections per 1 mm² of the surface.

To enhance the adhesiveness of the recording material in its rolled state, a lubricant, for example, a silicone oil based or fluorine based surface-active agent is used as a dispersion material or surface-active agent. It is preferable to use this together with the mat agent.

The film thickness of the back coat layer is 0.2 to 10μm, and preferably 0.2 to 5 μm.

On the other hand, A first conveyance path 64A for conveying the recording material 60 upward in a substantially vertical direction, and a second conveyance path 64B for conveying the recording material 60 downward in a substantially vertical direction are communicated in the cabinet 16A of the ink-jet printer 16 by a U-turn path 64C which reverses the conveying direction. A conveyance path 64 for conveying the recording material 60 longitudinally along a turning U-shaped path is formed. This conveyance path 64 corresponds to a conveyance path of the present invention. The magazine 62 is set in the cabinet 16A such that a recording material pull-out port formed in the magazine 62 is located at a lower end of the first conveyance path 64A.

On the first conveyance path 64A, the pair of pull out rollers 66 and the pairs of conveying rollers 68 and 70 are disposed in this order from a lower end side. The ink-jet printer 16 includes a drawing and conveying motor (not shown). The drawing and conveying motor is driven when the magazine 62 is set in the cabinet 16A, and applies rotation force to the roll of the recording material 60 accommodated in the magazine 62, to the pair of pull out rollers 66 and to the pair of conveying rollers 68 via an unillustrated transmission mechanism, thereby rotating the roll of the recording material 60. Thus, the recording material 60 is pulled out from the magazine 62, and is conveyed upward in the substantially vertical direction along the first conveyance path 64A.

Between the pairs of conveying rollers 68 and 70 is an image recording position for recording an image on the recording material 60. As will be described later, in the present embodiment, N images (N≧2, e.g., N=3)are concurrently recorded along the longitudinal direction of the recording material 60. Therefore, the distance between the pairs of conveying rollers 68 and 70 corresponds to the length of N image recording regions along the longitudinal direction of the recording material 60. A recording head 46 is disposed at a side of the first conveyance path 64A (at the image recording surface side of the material being conveyed along the first conveyance path 64A, the side at which the ink receiving layer is formed), and a platen 72 is disposed at the opposite side from the recording head 46 with respect to the first conveyance path 64A.

As shown in FIG. 3, the recording head 46 is supported by a guide rail 74 disposed along the longitudinal direction of the recording material 60. The recording head 46 can move in the longitudinal direction (direction of arrow A in FIG. 3) of the recording material 60 along the guide rail 74. When driving force of a scanning motor is transmitted through a driving force transmitting mechanism (these are not shown), the recording head 46 reciprocates over the N image recording regions of the recording material 60 along the longitudinal direction of the recording material 60.

Opposite ends of the guide rail 74 are supported by a pair of guide rails 76A and 76B disposed along the widthwise direction of the recording material 60. Support shafts 76C and 76D are supported between opposite ends of each of the pair of guide rails 76A and 76B. Thus, the guide rail 74 and the recording head 46 can move in the widthwise direction (direction of arrow B in FIG. 3) of the recording material 60 along the guide rails 76A and 76B. When the driving force of the scanning motor is transmitted through another driving force transmitting mechanism (not shown), the recording head 46 reciprocates over the N image recording regions of the recording material 60 along the widthwise direction of the recording material 60.

The driving of the scanning motor is controlled by the printer control section 42.

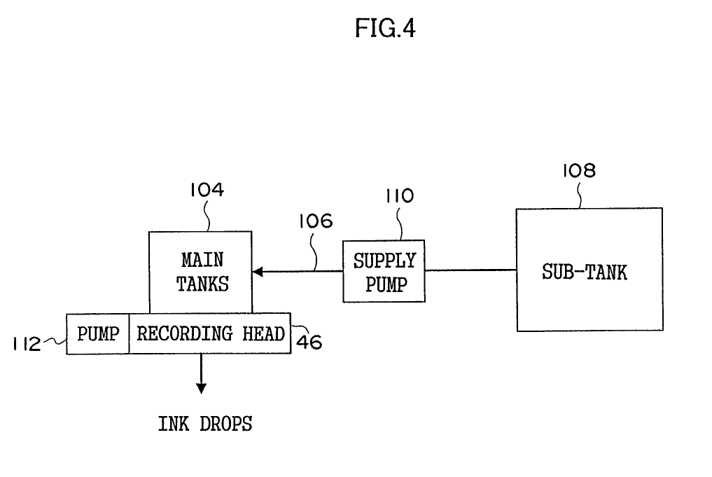

Although not illustrated in the drawings, in the recording head 46, nozzle trains comprising a large number of nozzles arranged along the widthwise direction of he recording material 60 are arranged in a plurality of lines along the longitudinal direction of the recording material 60. A plurality of ink chambers is formed in the recording head 46 in correspondence to the respective nozzle trains, and a plurality of main tanks 104 (see FIG. 4) which are respectively in communication with the plurality of ink chambers is mounted to the recording head 46. Ink of different colors (C, M, Y, BK) is stored in the main tanks, and the ink is supplied to the nozzle trains through the ink chambers. Thus, a different color ink for each nozzle train discharged from the nozzles.

As shown in FIG. 4, in the present embodiment, a plurality of hollow supply pipes 106 corresponding to the respective colors is provided for supplying the inks to the recording head 46. One ends of the supply pipes 106 are connected to the main tanks 104, and the other ends are connected to a plurality of sub-tanks 108 provided for the respective main tanks 104. Intermediate portions of the supply pipes are respectively provided with supply pumps 110 for supplying ink from the sub-tanks 108 to the main tanks 104.

Since the main tanks 104 mounted to the recording head 46 move integrally with the recording head 46, the ink storing capacity is limited in regard to weight, size and the like, but since limitations of weight and size of the sub-tanks 108 separate from the recording head 46 are slighter, the sub-tanks 108 have a storing capacity much greater than that of the main tanks 104. Therefore, it is possible to output 30,000 cm² or more of images with printing areas of 30% without replenishing ink to the sub-tanks 108.

As a discharging method for discharging the ink from the nozzle, various known discharge methods can be employed. As a representative method, it is possible to employ a piezoelectric element method in which a pulse voltage is applied to a piezoelectric element provided in the ink chamber so as to deform the piezoelectric element, thereby changing ink liquid pressure in the ink chamber. This change of ink liquid pressure is utilized to discharge the ink drop. It is also possible to employ a thermal method in which the ink is heated by a heating element provided in the ink chamber, and an ink drop is discharged from the nozzle by a bubble generated in the ink chamber by this heating. As shown in FIG. 4, a pump 112 which sucks ink from all the ink chambers in the recording head 46 is also mounted to the recording head 46, so as to overcome clogging of discharge ports of the nozzles.

The platen 72 disposed on the opposite side from the recording head 46 with respect to the first conveyance path 64A has a size corresponding to the N image recording regions on the recording material 60. The recording material 60 is maintained at a high planarity at the time of image recording by the platen 72 supporting the back surface. The first cutter 54, for cutting the recording material 60 in units of N image recording regions, is disposed between the platen 72 and the pair of conveying rollers 70.

The pairs of conveying rollers 71, 74, 76 and 78 are disposed in this order along the U-turn path 64C downstream in the conveying direction of the recording material 60 from the pair of conveying rollers 70. Guides 80 for guiding the recording material 60 that has been conveyed to the U-turn path 64C along the U-turn path 64C (reversing the conveying direction) are provided between each of the pairs of conveying rollers. The pairs of conveying rollers 82, 84, 86, 88 and 90 are disposed in this order along the second conveyance path 64B downstream from the pair of conveying rollers 78.

The pairs of conveying rollers 71, 74, 76 and 78 are connected to rotation shafts of conveyance retroversion motors (not shown) through transmission mechanisms (not shown), and the pairs of conveying rollers 82, 84, 86, 88 and 90 are connected to downward conveyance motors (not shown) through transmission mechanisms (not shown).

A heating and drying section 50, which dries the ink (more specifically, solvent included in the ink) by supplying hot air to the recording material 60 on which an image has been recorded by adhering ink drops discharged from the recording head 46, is provided on the second conveyance path 64B between the pairs of conveying rollers 82 and 84. A lamination portion 92 for forming a transparent high polymer film on an uppermost layer of the recording material 60 is provided between the pairs of conveying rollers 84 and 86.

The transparent high polymer film is for enhancing waterproofing and durability of the image and for maintaining high image quality for a long time. Here, transparent means that the image formed on the recording material can be observed through the high polymer film. Material of the transparent high polymer film is not limited, and various high polymer materials can be used. That is, water-soluble high polymers such as gelatin or polyvinyl alcohol, or hydrophobic high polymer such as polymethyl methacrylate may be used.

Examples of methods for forming the transparent high polymer film include (1) a method of affixing a previously prepared transparent high polymer film, (2) a method of applying a high polymer solution, (3) a method of applying a liquid coating agent on the surface after the image has been formed, and curing the agent by ultraviolet rays or infrared rays to form a transparent overcoat layer, (4) a method in which a resin porous layer of a thermoplastic is previously provided on the uppermost layer, an image is formed, and then the resin porous layer is heated (pressurized if necessary) to compact the layer to form a transparent resin film, and (5) a method of applying a latex polymer (which may be applied to the entire surface by ink jets), and heating and melting the same to form the transparent resin film.

In the present embodiment, the lamination portion 92 which forms the transparent high polymer film employs the method (1) as an example, but other methods may be employed. For example, if the method (4) is employed, it is possible to form the transparent high polymer film by heating the recording material 60 provided with the resin porous layer at the heating and drying section 50 (a heating section for forming the transparent high polymer film may be provided separately, of course). In the lamination portion 92 of the present embodiment, a transparent high polymer sheet 94 which is formed as a sheet and wound into a roll is affixed (laminated) to the recording material 60 by a pair of lamination rollers 96, thereby forming the transparent high polymer film on the uppermost layer of the recording material 60.

The image reading section 52 is provided between the pairs of conveying rollers 86 and 88 of the second conveyance path 64B. A 3-line CCD sensor (an area sensor may be used) 98 which reads a color image (output image) recorded on the recording material 60 is disposed at a side of the second conveyance path 64B (on the image recording surface side of the recording material 60 being conveyed along the second conveyance path 64B). A platen 100, which enhances planarity of the recording material 60 by supporting the back surface of the recording material 60 when the image is being read by the CCD sensor 98, is disposed on the opposite side from the CCD sensor 98 with respect to the second conveyance path 64B. The CCD sensor 98 constitutes a portion of the image reading section 52. Image signals are output from the CCD sensor 98, through an amplifier, an A/D converter and a correcting section (not shown), which makes corrections such as dark correction, which are also included in the image reading section 52, and input to the printer control section 42 as output image data representing the output image.

Further, the second cutter 56, which cuts the recording material 60 into individual images, is provided between the pairs of conveying rollers 88 and 90 of the second conveyance path 64B. An accommodation box 102 for accommodating the recording materials 60 which have been cut into individual images by the second cutter 56 is disposed below the pair of conveying rollers 90.

Next, operation of the present embodiment will be explained. The magazine 62 is set in the cabinet 16A of the ink-jet printer 16. When an instruction is given to record an image on the recording material 60, the printer control section 42 drives the drawing and conveying motor to pull out the recording material 60 from the magazine 62 and convey the same. When a sensor (not shown) detects that a tip end of the recording material 60 has reached a position at the first cutter 54, driving operation of the drawing and conveying motor is stopped, thereby stopping the conveyance of the recording material 60. The image is recorded on the recording material 60 by the recording head 46. While the image is recorded, a state in which the driving operation of the drawing and conveying motor is stopped is maintained.

The image is recorded on the recording material 60 in the following manner. That is, in the present embodiment, N images (e.g., N=3) are concurrently recorded on the recording material 60 located at the image recording position. For this, the printer control section 42 reads out recording image data of the N images to be recorded from the image data storing section 40. Based on the recording image data of the N images, an image signal indicating operation timing of each nozzle of the recording head 46 (energizing timing of the piezoelectric element or heater provided corresponding to each of the nozzles) so that the N images as represented by the recording image data are recorded on the recording material 60, in units of dots for each of the color components (e.g., C, M, Y, BK) with a longitudinal direction of the recording material 60 as a main scanning direction, is output to the driver 44. The recording head 46 reciprocates along the guide rail 74 (along the longitudinal direction of the recording material 60) at a predetermined moving speed, and in this state, the scanning motor is driven such that the recording head 46 and the guide rail 74 gradually move along the guide rails 76A and 76B (along the widthwise direction of the recording material 60).

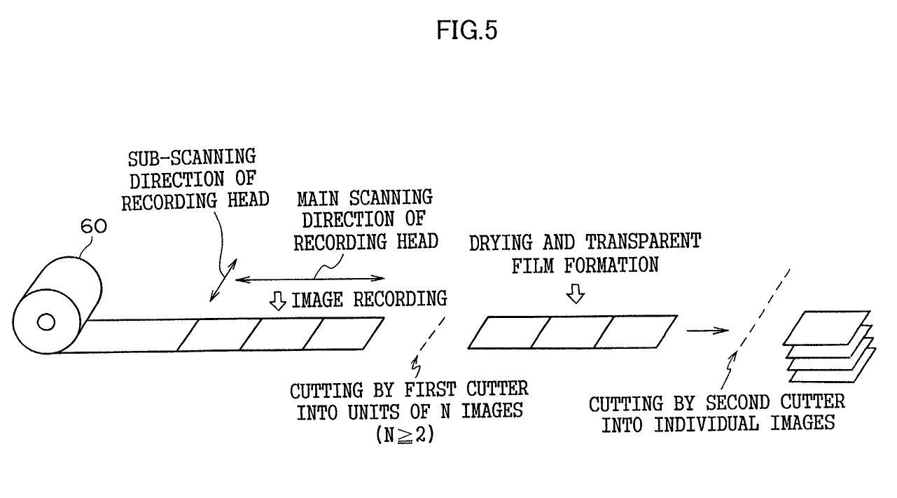

The driver 44 generates a discharge signal which selectively drives each nozzle at timing in accordance with the image signal (selectively energizing the piezoelectric element or the heater of each nozzle) based on the image signal input from the printer control section 42, and applies the generated discharge signal to the recording head 46. Thus, ink drops discharged from each nozzle of the recording head 46 at timings, in accordance with the image signal adhere to the recording material 60, the recording head 46 reciprocates along the longitudinal direction of the recording material 60 so that main scanning is carried out, the recording head 46 (and the guide rail 74) moves along the widthwise direction of the recording material 60 so that sub-scanning is carried out (see FIG. 5), and N color images are concurrently recorded on N image recording regions on the recording material 60 in units of dot rows of the same number as the nozzles constituting the nozzle train.

In the present embodiment, since the N images are concurrently recorded in this manner, it is possible to shorten the recording time per image. Further, for reciprocative motion of the recording head 46, in addition to time required for the recording head 46 to actually record the images, time for deceleration and stopping of the recording head 46 and for accelerating to a predetermined speed in the opposite direction is also required. In the present embodiment, the main scanning direction of the recording head 46 is set to the longitudinal direction of the recording material 60 (longitudinal direction of the N image recording regions), and the recording head 46 reciprocates along the longitudinal direction of the recording material 60. Thus, the number of reciprocating motions of the recording head 46 for recording the N images in the N image recording regions is reduced, and it is possible to further shorten the recording time per image.

When the recording of the N images has been completed, the printer control section 42 drives the drawing and conveying motor and the conveyance retroversion motor, sending the tip end of the recording material 60 into the U-turn path 64C. When a portion of the recording material 60 corresponding to a rear end of the region where the N images are recorded reaches the position at the first cutter 54, the driving operation of the drawing and conveying motor and the conveyance retroversion motor is stopped, and the first cutter 54 is operated. Thus, as shown in FIG. 5 as an example, a portion of the recording material 60 on which the N images have been recorded by the recording head 46 is cut and separated from a portion of the recording material 60 where images are not yet recorded.

When the first cutter 54 is actuated, the printer control section 42 drives the conveyance retroversion motor and downward conveyance motor so that the piece of the recording material 60 on which the N images has been recorded is conveyed downstream from the first cutter 54 along the longitudinal direction of the recording material 60, and processing for concurrently recording the N images to be recorded next is carried out for the N image recording regions of the recording material 60 now located at the image recording position.

In the present embodiment, since the plurality of images are recorded along the longitudinal direction of the recording material 60 in this manner, it is possible to reduce the width of the recording material 60, operability when the roll of the recording material 60 is mounted to the magazine 62 and when the magazine 62 is set in the ink-jet printer 16 is enhanced, and the ink-jet printer 16 can be reduced in size.

Further, the recording material 60 is pulled out from the magazine 62 along the longitudinal direction of the recording material 60 and, after the images are recorded on the recording material 60, the pieces of the recording material 60 on which the images are recorded are conveyed along the longitudinal direction of the recording material 60. Therefore, it is unnecessary to provide a handover mechanism for receiving and delivering the recording material 60 between a plurality of conveyance mechanisms, and it is possible to simplify the structure of the ink-jet printer 16.

Further, the conveyance path 64 of the recording material 60 comprises the conveyance path 64A and 64B, which convey the recording material 60 substantially in the vertical direction, and U-turn path 64C connecting therebetween, and the conveyance path of the recording material 60 forms an inverted U-shape. Therefore, it is possible to remarkably reduce the floor area which is required for the ink-jet printer 16.

After the conveying direction is reversed by the U-turn path 64C, the piece of the recording material 60 is heated by the heating and drying section 50 so that solvent included in the recording liquid drops discharged and adhered from the recording head 46 is removed, and the transparent high polymer sheet 94 is laminated by the lamination portion 92. The heating and drying section 50 and the lamination portion 92 correspond to post-processing means of the present invention.

The piece of the recording material 60 on which the N images have been recorded can easily resist meandering at the time of conveyance as compared with a case in which the recording materials is cut into individual images. Therefore, especially when the lamination portion 92 laminates the transparent high polymer sheet 94 to the recording material 60, it is possible to easily suppress positional deviation of a lamination position of the transparent high polymer sheet 94 with respect to the piece of the recording material 60.

The recording material 60 (piece) laminated with the transparent high polymer sheet 94 may be subjected to at least one of a heating operation and a crimping operation, thereby enhancing the flatness of the transparent film formed on the uppermost layer of the recording material 60. The images recorded on the piece of the recording material 60 on which the transparent film has been formed by the lamination portion 92 are sequentially read by the image reading section 52, and then the piece is cut into individual images by the second cutter 56 (see FIG. 5) and accommodated in the accommodation box 102.

A structure in which the single recording head 46 is moved in the main scanning direction and sub-scanning direction to record the N images concurrently has been explained above, but the present invention is not limited to this structure. It is possible to employ a structure in which a plurality of recording heads 120 are arranged at intervals from one another along the longitudinal direction of the recording material 60, the recording material 60 is moved at a constant speed and, in this state, the images are recorded by the recording heads 120 and the N images are recorded concurrently.

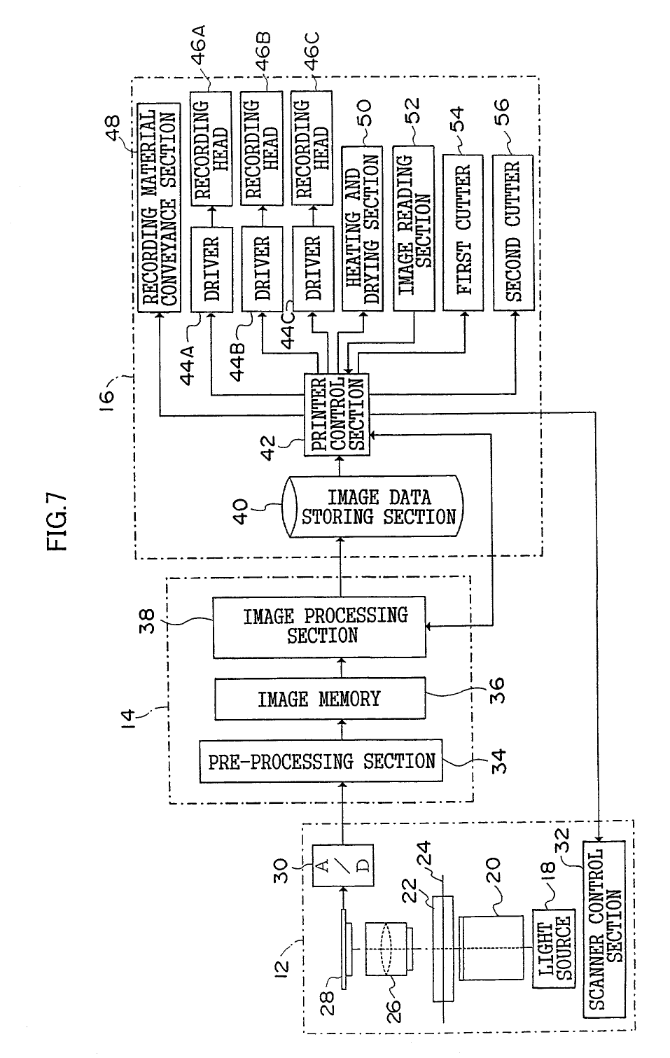

FIG. 7 shows an outline structure of an image recording system of a second embodiment of the present invention. In the ink-jet printer 16, which is an output apparatus, the image recording system of this embodiment is different from the first embodiment using the single recording head 46 in that three recording heads 46A, 46B and 46C are used. Therefore, the film scanner 12 and the image processing apparatus 14 which are input apparatuses can employ the same structures as those of the first embodiment. Only different structures will be explained for the second embodiment, explanations in the first embodiment are employed for the structures of the film scanner 12, the image processing apparatus 14 and the like, and identical explanations are omitted. Other explanations of the first embodiment, e.g., the explanation concerning the recording material, apply to the second embodiment unless the explanation violates the meaning and nature of the second embodiment.

In FIGS. 7 to 11 concerning the second embodiment, identical elements are designated with the same reference symbols, and identical explanations will be omitted.

As in the first embodiment of the present invention, image data which has been subjected to various image processings is conveyed to the image data storing section 40 as recording image data and is temporarily stored therein. The printer control section 42 is connected to the image data storing section 40 of the ink-jet printer 16. The printer control section 42 is connected to the scanner control section 32 of the film scanner 12 and the image processing section 38 of the image processing apparatus 14. As will be described in detail later, the ink-jet printer 16 is provided with the three recording heads 46A, 46B and 46C. The recording heads 46A to 46C are connected to the printer control section 42 through drivers 44A, 44B and 44C. The recording material conveyance section 48, the heating and drying section 50, the image reading section 52, the first cutter 54 and the second cutter 56 are connected to the printer control section 42.

The recording material conveyance section 48 corresponds to the conveyance mechanism of the present invention. The recording material conveyance section 48 comprises a later-described drawing and conveying motor, conveyance retroversion motor, downward conveyance motor, pair of pull out rollers 66, and pairs of conveying rollers 68, 70, 74, 76, 78, 82, 84, 86, 88, 90. The first cutter 54 and the second cutter 56 correspond to the cutting means of the present invention; more particularly, the first cutter 54 corresponds to the first cutting means, and the second cutter 56 corresponds to the second cutting means.

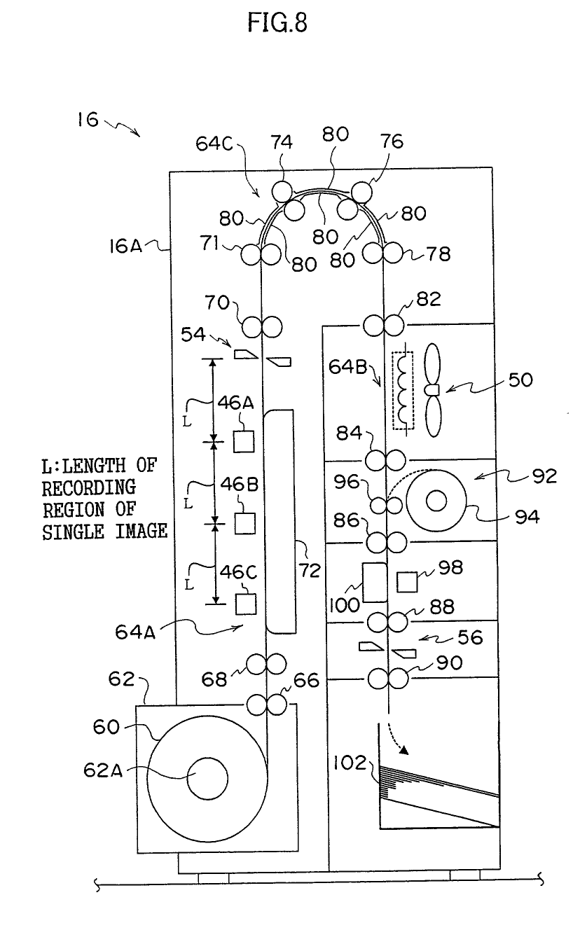

As shown in FIG. 8, the cabinet 16A of the ink-jet printer 16 is formed into a vertically long, substantially box-like shape. The magazine 62 for accommodating the recording material 60 is set at the side in the vicinity of the lower end of the cabinet 16A. The recording material 60 is formed into the long sheet, and is shipped wound around the outer periphery of the roll core 62A in a roll such that the image recording surface of the recording material 60, the surface where the ink receiving layer is formed faces inside. After the recording material 60 is mounted in the magazine 62, when the recording material 60 is to be used for recording images, the magazine 62 is set to the cabinet 16A, and the recording material 60 is set in a predetermined position (the position shown in FIG. 8).

The first conveyance path 64A for conveying the recording material 60 upward in the substantially vertical direction, and the second conveyance path 64B for conveying the recording material 60 downward in the substantially vertical direction are connected in the cabinet 16A of the ink-jet printer 16 via the U-turn path 64C which reverses the conveying direction. The conveyance path 64 for conveying the recording material 60 in the longitudinal direction along the inverted U-shaped path is formed. This conveyance path 64 corresponds to a conveyance path of the present invention. The magazine 62 is set in the cabinet 16A such that the recording material pull-out port formed in the magazine 62 is located at a lower end of the first conveyance path 64A.

On the first conveyance path 64A, the pair of pull out rollers 66 and the pairs of conveying rollers 68 and 70 are disposed in this order from the lower end side. The ink-jet printer 16 includes the drawing and conveying motor (not shown). The drawing and conveying motor is driven when the magazine 62 has been set in the cabinet 16A, and applies rotation force to the roll of the recording material 60 incorporated in the magazine 62, the pair of pull out rollers 66 and the pair of conveying rollers 68 through a transmission mechanism, thereby rotating the roll of the recording material 60. Thus, the recording material 60 is pulled out from the magazine 62, and is conveyed upward in the substantially vertical direction along the first conveyance path 64A.

Positions between the pairs of conveying rollers 68 and 70 are the image recording position for recording images on the recording material 60. In the present embodiment, N images are concurrently recorded along the longitudinal direction of the recording material 60 (N≧2; in the present embodiment, N=3 as an example). Therefore, the distance between the pairs of conveying rollers 68 and 70 is such that the N images can be recorded concurrently. The three recording heads 46A to 46C are disposed at a side of the first conveyance path 64A at different positions along the first conveyance path 64A (at the image recording surface side of the recording material 60 (the side on which the ink receiving layer is formed)), and the platen 72 is disposed on the opposite side from the recording heads 46A to 46C of the first conveyance path 64A.

In the present embodiments, since three images are concurrently recorded by the three recording heads 46A to 46C, positions of the recording heads 46A to 46C are adjusted such that the distances between the image recording positions of the recording heads coincide with a length L (image recording pitch of the recording material 60) along the longitudinal direction of the recording material 60 of a recording range of a single image. The number of images to be concurrently recorded N and the number of recording heads M are in a relation of N≧2 and M≧2, and it is not necessary that N=M.

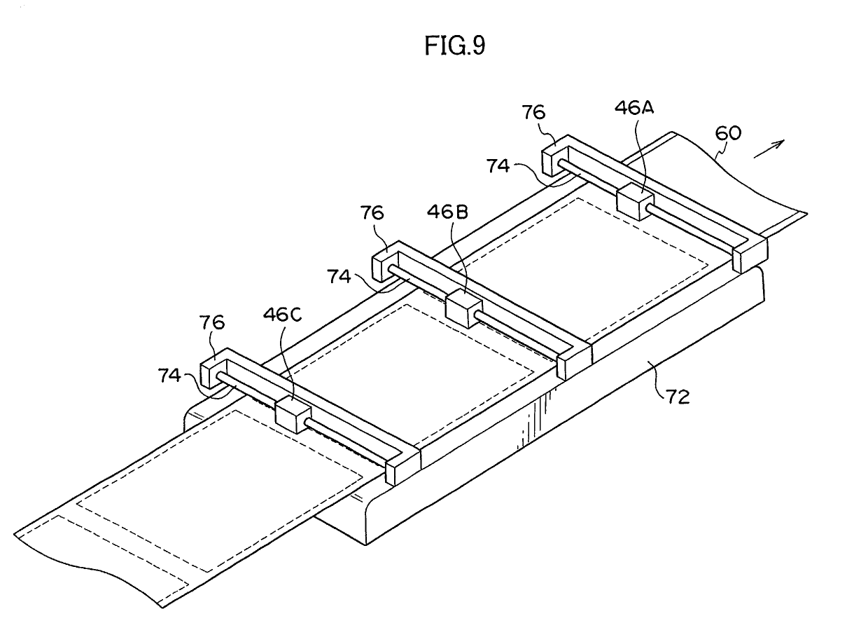

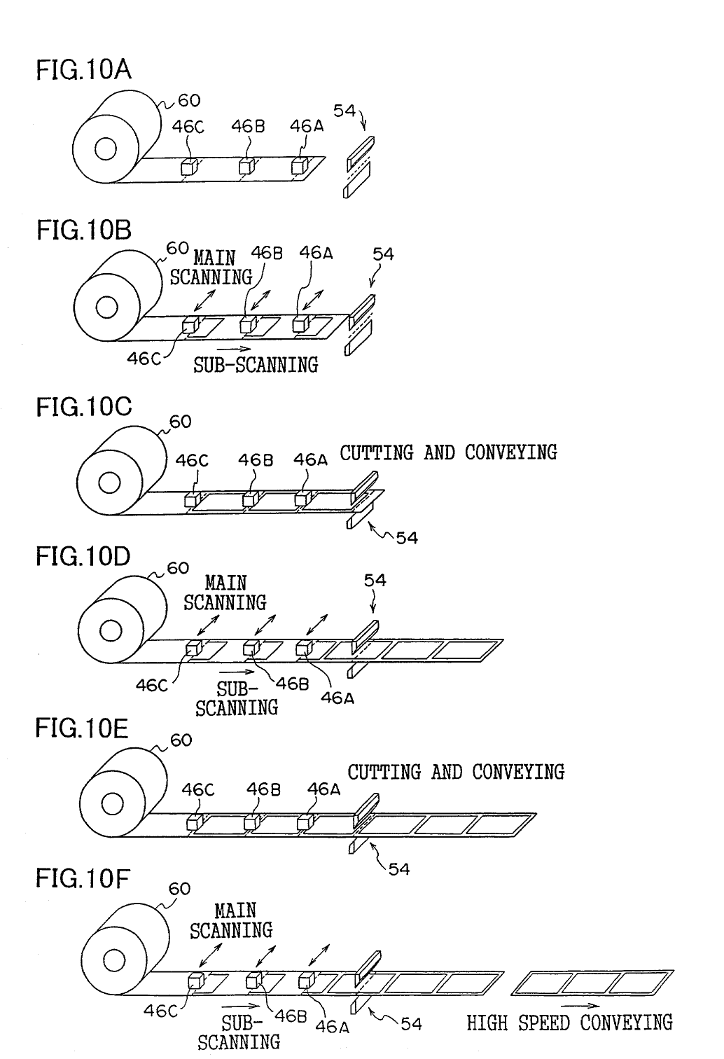

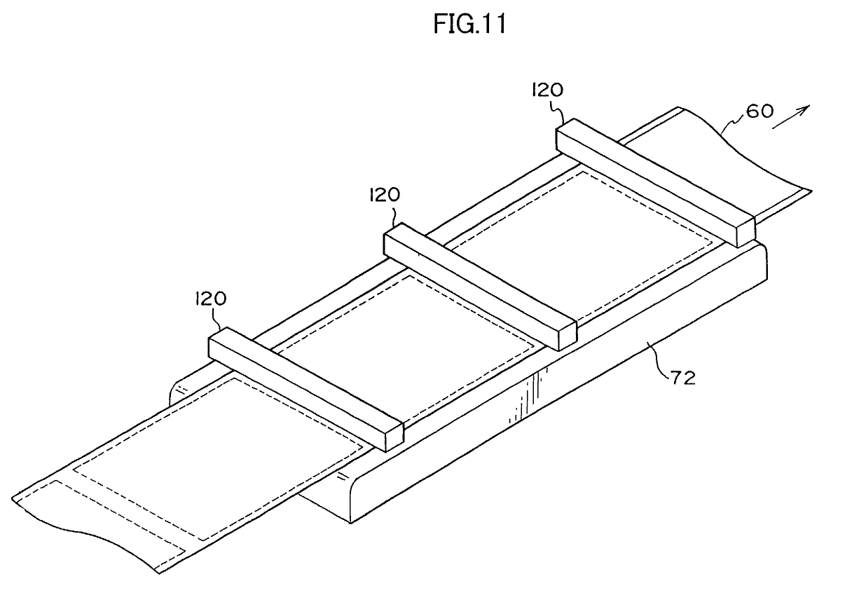

As shown in FIG. 9, the recording heads 46A to 46C are respectively supported by the guide rails 74 disposed along the widthwise direction of the recording material 60, and opposite ends of each guide rail 74 are supported by U-shaped frames 76. The recording heads 46A to 46C can move in the widthwise direction of the recording material 60 along the guide rails 74, and three sets of driving force transmitting mechanisms and scanning motors are provided for reciprocating the recording heads 46A to 46C. The driving forces of the scanning motors are transmitted through the driving force transmitting mechanisms so that the recording heads 46A to 46C independently reciprocate along the widthwise direction of the recording material 60.

As the driving force transmitting mechanism for reciprocating each recording head 46, it is possible to employ a mechanism in which an endless belt, to which the recording head 46 is retained, is wound around a pair of pulleys, and one of the pulleys is rotated by driving force of the scanning motor, thereby moving the endless belt and the recording head 46. The recording head 46 may be moved using, for example, a known screw transmission mechanism. The driving operation of each scanning motor is controlled by the printer control section 42. The scanning motor may correspond to moving means of the present invention together with the various members for moving the recording head 46 shown in FIG. 3 and the driving force transmitting mechanism; and the recording heads 46A to 46C and the drivers 44A to 44C connected to the recording heads may correspond to recording means of the present invention.

Since the recording heads 46A to 46C have the same structure, structure will be explained without distinguishing the three recording heads

Although not illustrated in the drawings, in the recording head 46, nozzle trains each comprising a large number of nozzles arranged along the longitudinal direction of the recording material 60 are- arranged in a plurality of lines along a widthwise direction of the recording material 60. A plurality of the ink chambers is formed in the recording head 46 in correspondence to the respective nozzle trains, and a plurality of the main tanks 104 (see FIG. 4) which are respectively in communication with the plurality of ink chambers are mounted to the recording head 46. Ink of different colors (C, M, Y, BK) is stored in the main tanks, and the ink is supplied to the nozzle trains through the ink chambers. Thus, different color inks are discharged from the nozzles of the nozzle trains.

The back surface of the recording material 60 is supported by the platen 72, which is disposed on the opposite side from the recording head 46 with respect to the first conveyance path 64A, when the images are recorded by the recording heads 46, so that the recording material 60 is maintained at a high planarity while the images are recorded. The first cutter 54 for cutting the recording material 60 in individual images recording regions of three frames is disposed between the platen 72 and the pair of conveying rollers 70. The disposition of the first cutter 54 is adjusted such that the recording material 60 is cut at a length L away from the image recording position of the recording head 46A, which is disposed furthest downstream among the recording heads 46A to 46C in the conveying direction of the recording material 60.

Next, operation of the present embodiment will be explained. The magazine 62 is set in the cabinet 16A of the ink-jet printer 16. When it is instructed to record an image on the recording material 60, the printer control section 42 drives the drawing and conveying motor to pull out the recording material 60 from the magazine 62 and convey the same at relatively high speed. When it is determined that the tip end of the recording material 60 has reached the image recording position by the most downstream recording head 46A, shown in Fig. LOAD, for example, (this determination is made by detecting when the recording material 60 passes a passing-detection sensor provided at an intermediate portion of the conveyance path 64A or by detecting the amount pulled out and conveyed of the recording material 60), the driving operation of the drawing and conveying motor is controlled such that the recording material 60 is conveyed at a conveyance speed (a relatively low constant speed) for recording images, and the images are recorded on the recording material 60 by the recording heads 46A to 46C.

The images are recorded on the recording material 60 in the following manner. That is, in the present embodiment, to concurrently record the three images in the recording material 60, the printer control section 42 reads the recording image data of three images to be recorded (all the images may be the same or different images may be mixed or all the images may be different) from the image data storing section 40. Based on the recording image data of each read image, image signals expressing driving timing of each nozzle of the recording heads 46A to 46C (e.g., energizing timing of the piezoelectric element or the heater provided in correspondence to each nozzle) such that the images can be recorded on the recording material 60 in dot units for each of the color components (e.g., C, M, Y, BK) with the widthwise direction of the recording material 60 being the main scanning direction, are output to the drivers 44A to 44C of the recording heads 46A to 46C corresponding to the respective images. The scanning motors respectively corresponding to the recording heads 46 are driven such that the recording heads 46 reciprocate along the guide shafts 74 (along the widthwise direction of the recording material 60) at a predetermined speed.

The drivers 44A to 44C of the recording heads 46 generate discharge signals which selectively drive each nozzle (selectively energize the piezoelectric element or the heater of each nozzle) at timings in accordance with the image signals, based on the image signals input from the printer control section 42, and applies the generated discharge signals to the recording heads 46. Thus, the ink drops discharged in accordance with the image signals from each nozzle of the recording heads 46A to 46C adhere to the recording material 60, the recording heads 46 reciprocate along the longitudinal direction of the recording material 60 so that main scanning is carried out, the recording material 60 is conveyed at the image recording conveyance speed so that sub-scanning is carried out (see FIG. 10B), and three color images are concurrently recorded on the recording material 60 along the longitudinal direction of the recording material 60.

Since the three images are concurrently recorded in the present embodiment in this manner, it is possible to shorten the recording time per image. Further, since a plurality of images is recorded along the longitudinal direction of the recording material 60, a narrow recording material can be used as compared with a case in which a plurality of images are recorded along the widthwise direction of the recording material 60, it is possible to reduce the size of the mechanism which reciprocates the recording heads 46 (the guide rails 74, the frames 76, driving force transmitting mechanisms and the like), and it is possible to reduce the ink-jet printer 16 in size.

In the present embodiment, since the main scanning is carried out by reciprocating the three recording heads 46 along the widthwise direction of the recording material 60, although the apparatus structure is slightly complicated since the mechanism for reciprocating the recording heads 46 is required as compared with a case in which a recording head has a large number of nozzles continuously arranged from one end in the widthwise direction of the recording material 60 to the other end (see FIG. 11, details thereof will be described later), the maintenance of the recording head 46 is facilitated because the number of nozzles of the recording head 46 is greatly reduced.

In the present embodiment, since the image recording positions of the recording heads 46A to 46C and the cutting position of the first cutter 54 are located at intervals from each other corresponding to the length L along the longitudinal direction of the recording material 60, the recording range of a single image, when the recording operation of the three images by the recording heads 46A to 46C is completed, a boundary at the tip end side of the image recording region in which the image is recorded by the recording head 46A is located at the cutting position of the first cutter 54. Accoridingly, the printer control section 42 operates the first cutter 54 to cut the recording material 60.

The printer control section 42 next drives the drawing and conveying motor and the conveyance retroversion motor, and the recording material 60 is conveyed at a relatively high speed such that a boundary at a rear end side of the image recording region in which the image was recorded by the recording head 46C is located at the image recording position of the recording head 46A. When this boundary reaches the image recording position of the recording head 46A, the conveyance speed of the recording material 60 is switched to the image recording conveyance speed, and the next three images are concurrently recorded on the recording material 60 by the recording heads 46A to 46C (see FIG. 10D).

When the recording of this next three images is completed, as shown in FIG. 10E, a boundary between the recording region of the three images previously recorded and the recording region of the next three images is located at the cutting position of the first cutter 54. Accordingly, the printer control section 42 operates the first cutter 54 to cut the recording material 60, and the piece of the recording material 60 on which the previous three images ware recorded is separated from the main body of the recording material 60.

When the first cutter 54 has operated, the printer control section 42 drives the conveyance retroversion motor and the downward conveyance motor and, as shown in FIG. 10F, the piece of the recording material 60 on which the three images are recorded is conveyed downstream from the first cutter 54 at a high speed along the longitudinal direction of the recording material 60. The recording material 60 is conveyed such that a boundary of the rear end side of the recording region of the next three images reaches the recording head 46A, and then the conveyance speed of the recording material 60 is switched to the image recording conveyance speed, and another three images are concurrently recorded on the recording material 60 by the recording heads 46A to 46C (see FIG. 10D). Processing ability maintenance process Hereafter, a processing ability maintenance process carried out by the printer control section 42 will be explained with reference to FIGS. 1 to 6. The processing ability maintenance process may be carried out in both of the first and second embodiments. Thus, unless otherwise specified, the explanation concerning the processing ability maintenance process can be applied to either of the embodiments. In the processing ability maintenance process, in a state in which a large number of images are being continuously recorded on the recording material 60, the printer control section 42 monitors for occurrence of (1) clogging of the discharge ports of the recording head 46, (2) lowering of discharge amounts of ink the drops from the recording head 46, (3) failure of image output for other reasons, (4) lowering of spare capacity of the image data storing section 40, and (5) consumption of all the recording material 60, and for recording of the images.

Concerning events (1) to (3), it is monitored whether such events have occurred by using output image data from the image reading section 52. More specifically, the printer control section 42 causes the image reading section 52 to read a portion or all the output images which have been outputted by recording the images on the recording material 60 by ink-jet printer 16 (preferably all; each image may be read or one every or several frames but when a plurality of recording heads are provided, it is preferable to read images recorded by each recording head 46 at the same rate).

The recording image data input to the inkjet printer 16 from the image processing apparatus 14 and accumulated and stored in the image data storing section 40 is kept in the image data storing section 40 until it is determined that the image quality of the corresponding output image is appropriate. To compare the obtained output image data with the recording image data, on one of the output image data and the recording image data, the printer control section 42 first carries out a resolution conversion for coinciding the resolution with the other image data, and then carries out image processing such as density conversion for coinciding the average image density with the other image data.

The resolution of the output image data and the recording image data may be converted to the same low resolution to avoid a deterioration of determining precision of later-described processing, which could be caused by fine deviation of pixel positions, and to shorten the processing time.

Next, densities of each color component of the output image data and the recording image data subjected to the above image processing are compared with each other in units of one pixel, and it is determined whether there are pixels whose density value of each color component is different by a predetermined value or greater after errors are accounted for. When the density differences between the recording image data and the pixel of each color component are all less than the predetermined value, the image quality of the output image is an appropriate image quality which substantially coincides with the image expressed by the recording image data, and it is determined that the events (1) to (3) have not occurred. Thus, the processing for the output image is completed, and the corresponding recording image data is erased from the image data storing section 40.

On the other hand, if there are pixels whose density difference of the recording image data for a color component is equal to or greater than the predetermined value, the number of pixels and their distribution on the image are determined. For example, if the number of pixels whose density difference of the recording image data for each color component is greater than the predetermined value is extremely small, and whose distribution is not concentrated on a certain portion on the image, a visible variation in image quality will not occur, and it is determined that the events (1) to (3) have not occurred. Therefore, the processing for the output image is completed, and the corresponding recording image data is erased from the image data storing section 40.

Only a portion of the output images may be read, for example, if it is determined that the events (1) to (3) were not generated for the foremost and rearmost image positions in the recording order, the recording image data may be erased from the image data storing section 40.

When there are more than a predetermined number of pixels whose density difference of the recording image data for a color component is greater than the predetermined value, it is determined that one of events (1) to (3) are has occurred, erasure of the corresponding recording image data from the image data storing section 40 is cancelled, and it is determined whether the pixels whose density difference of the recording image data for each color component is greater than the predetermined value are continuous in a direction corresponding to the longitudinal direction of the recording material 60.

In the recording head 46 of the first embodiment, when clogging occurs in the discharge port of a certain nozzle, and when a certain color ink is not discharged from that the liquid discharge port or the discharge amount of the certain color ink becomes small, the portion where the certain color is lost appears on the output image as a defect which is continuous in the form of a stripe along the longitudinal direction of the recording material 60. Further, the image is recorded by the recording head 46 in such a manner that the recording head 46 is reciprocated along the longitudinal direction of the recording material 60 and the recording head 46 is gradually moved in the widthwise direction of the recording material 60. Thus, the above defect appears periodically along the widthwise direction of the recording material 60.

With the recording heads 46 of the second embodiment, when clogging occurs in the discharge port of a certain nozzle and a certain color ink is not discharged from the liquid discharge port or the discharge amount of the certain color ink becomes small, a portion where the certain color is lost appears on the output image as a defect which is continuous in the form of a stripe along the widthwise direction of the recording material 60. Further, the image is recorded by the recording heads 46 in such a manner that the recording heads 46 are reciprocated along the widthwise direction of the recording material 60 and the recording material 60 is conveyed in the longitudinal direction. Thus, the above defect appears periodically along the longitudinal direction of the recording material 60.

When clogging occurs in a discharge port of a certain nozzle of the recording head 46 of the first embodiment or a certain recording head 46 of the second embodiment, the same defect appears in a plurality of output images. Thus, when the defect is detected, it is determined whether the defect exists for a plurality of output images recorded in a short time. When the defects are detected from the output images, it is determined whether the frequency of appearance of the defects is constant. Thus, it is possible to further enhance the precision of determination of clogging of the discharge ports.

In the first embodiment, when the above condition is satisfied, the printer control section 42 determines the event (1), i.e., clogging has occurred n the discharge port of a certain nozzle of the recording head 46. Recording operation of images by the recording head 46 is temporarily discontinued, and the clogging of the discharge port is overcome by operating the pump 112. When clogging occurs in the discharge ports of a the large number of nozzles at the same time, a portion or all of the output image is damaged, or this may have happened even when the image is not recorded at all. In such cases also, the above conditions are satisfied and thus clogging of the discharge ports of recording head 46 is overcome. The output image from which the defect was detected is discarded as being abnormal. When it is determined that the clogging of the discharge port has been overcome, that image is again recorded using the recording image data kept in the image data storing section 40.

In the second embodiment, the same processing is carried out for the certain recording head in which clogging has occurred.

It is necessary to temporarily discontinue the recording operation of the image so as to actuate the pump 112 as described above. Therefore, if the destiny variation (reduction of discharge amounts of ink drops) caused by the clogging of the discharge port is relatively small, and if it is possible to specify the nozzle with the clogging of the discharge port, only the discharge signal which drives that certain nozzle may be changed so as to compensate for the density variation caused by the clogging in the discharge port.

In some cases, the clogging of the discharge port of the recording head 46 is not overcome by actuating the pump 112. In such a case, an alarm is actuated to call an operator. In the second embodiment, until the clogging of the discharge port of the recording head 46 is overcome by an operator′s maintenance operation, the image recording operation is continued using only the recording heads 46 in which clogging of the discharge ports has not occurred utilizing the fact that the three recording heads 46 are provided. Thus, even when a clog which is difficult to overcome even when the pump 112 is actuated occurs, it is possible to prevent the number of images recorded per unit time by the ink-jet printer 16 from being greatly reduced.

If the number of recording heads 46 which record images is changed, the number of images to be recorded concurrently is also varied, and when clogging of a discharge port occurs in one of the three recording heads 46, the images are recorded using two recording heads 46 and thus two frame images are concurrently recorded in each image recording cycle. Thus, the printer control section 42 may control the operation of the first cutter 54 such that the recording material 60 is cut into units of two frames or a multiple of two frames (e.g., 4) by the first cutter 54.

If the number of pixels whose density difference of the recording image data of a color component is more than the predetermined value is more than the predetermined number, and the pixels whose density difference of the recording image data of each color component is more than the predetermined value are distributed substantially uniformly over the entire output image, i.e., when the color of the image is changed overall, the printer control section 42 determines that the event (2) has occurred, i.e., that the discharge amounts of the ink drops from the recording head 46 has reduced for a certain color. The printer control section 42 temporarily discontinues the image recording operation by the recording head 46, and actuates the supply pumps 110 to supply the certain color to the main tanks 104 from the sub-tanks 108.

Thus, if the reason why the discharge amounts of the ink drops are reduced is a shortage in ink supply to the recording head 46, the reduction in discharge amount can be overcome by actuating the supply pumps 110. The output image which satisfies the above conditions is discarded as an abnormal image and, after it is determined that the supply shortage of ink has been overcome, the image is again recorded using the recording image data kept in the image data storing section 40.

Also, when the discharge amount of ink drops from the recording, head 46 is reduced, color is changed in the same manner for a plurality of output images (density differences of a certain color component exist in more than a predetermined number distributed substantially uniformly over the entire output image). Therefore, when the deterioration of image quality has been detected, by determining whether the variation in color has occurred in a plurality of output images recorded in a short time, it is possible to further enhance the precision of determination of the discharge amount reduction of ink drop from the recording head 46.

The discharge amounts of the ink drops from the recording head 46 may be reduced by causes other than a supply shortage of ink, and thus there is a possibility that the discharge amount reduction will not be overcome even when the supply pump 110 is actuated. In such a case, instead of actuating the supply pumps 110, the discharge signal for driving each nozzle which discharges the certain color ink whose ink drop discharge amount is reduced may be varied to compensate for the reduction of discharge amounts (reduction of density).

When the discharge amounts of ink drops from the recording head 46 are extremely reduced and the extreme reduction of the discharge amount is not overcome even when the supply pump 110 is actuated, it is considered that the cause is that all the ink stored in the sub-tanks 108 has been consumed. In such a case, it will be difficult to overcome the reduction of discharge amounts even if the discharge signal is varied. Therefore, an alarm is actuated to call an operator. Thus, it is possible to prevent the number of processing sheets per unit time from being reduced, which could happen if a state in which the discharge amount is extremely reduced, i.e., a state in which the image can not be normally recorded, is continued.

When a plurality of the recording heads are provided as in the second embodiment, the image recording operation may be continued using only recording heads 46 other than the recording head 46 whose discharge amount is extremely reduced.

When a deterioration in image quality such as defects or color change has been detected but image quality deterioration has not occurred in other output images, it is possible to determine that the detected image quality change is a sudden temporary image quality deterioration caused by, for example, garbled data caused when the recording image data was conveyed or a temporary voltage variation of a power source during the image recording operation. In such a case, the printer control section 42 determines that output image failure has been caused by the event (3) other reasons, and only that output image whose image quality deterioration has been detected is recorded again using the same recording image data. Thus, an output image having appropriate image quality can be obtained in most cases.

A spare capacity reduction of the image data storing section 40, event (4), can be detected by always monitoring the spare capacity of the image data storing section 40. More specifically, the printer control section 42 stores the spare capacity of the image data storing section 40. When recording image data output from the image processing apparatus 14 is stored in the image data storing section 40, the stored spare capacity is reduced by the data amount of the recording image data to be stored. When it is determined that the image quality of an output image is appropriate and the corresponding recording image data is erased from the image data storing section 40, the stored spare capacity is increased by the data amount of the erased recording image data.

Whenever the stored spare capacity is altered, it is determined whether the altered spare capacity is equal to or less than a predetermined value. When this determination is negative, no processing is carried out, but, for example, if clogging of discharge ports of the recording head 46 has occurred, the image recording operation has been temporarily discontinued for actuating the pump 112 and it is necessary to again record the image for which a defect has occurred, the spare capacity of the image data storing section 40 is reduced until the re-recording operation of the image is completed, then the possibility that the determination is positive is high. When the determination is positive, the image processing apparatus 14 is requested to temporarily discontinue output of recording image data.

Thus, it is possible to avoid a case in which the image data storing section 40 is filled to capacity while recording image data input from the image processing apparatus 14 continues to be stored in the image data storing section 40, a communication sequence for conveying the recording image data is stopped, and image recording operations in the ink-jet printer 16 can not be carried out, or processing in the image processing apparatus 14 is stopped halfway through a task.

When image recording operations on the recording material 60 are carried out using image data which is sequentially output from the film scanner 12 by continuously reading film images at the film scanner 12, it is possible to request the film scanner 12 to temporarily stop reading the film images instead of requesting the image processing apparatus 14 to stop the output of the recording image data.

Consumption of all the recording material 60, event (5), can be detected by determining when a load applied to the drawing and conveying motor when the motor is driven is equal to or less than a predetermined value. When it is determined that all of the recording material 60 accommodated in the magazine 62 has been consumed, an alarm is actuated to call an operator. Thus, it is possible to prevent the number of processing sheets per unit time from being reduced,as may be caused if a state in which the magazine 62 is not replaced, i.e., a state in which images can not be recorded, is continued.

Next, the processing ability maintenance process carried out by the image processing section 38 of the image processing apparatus 14 will be explained. In the processing ability maintenance process by the image processing section 38, the ink-jet printer 16 monitors for (6) a failure of the film scanner 12, or (7) a reading error of the photographic film 24 by the film scanner 12, during image recording operations in a state in which a large number of images are continuously recorded on the recording material 60.

When a communication error with the film scanner 12 occurs the image processing section 38 determines that event (6) has occurred, i.e., a failure in the film scanner 12. When an abnormal condition such that the density of all pixels is extremely high or low occurs in the image data input from the film scanner 12, the image processing section 38 determines that event (7) has occurred, i.e., a reading error in the film scanner 12.

When it has been determined that the event (6) or (7) has occurred, an alarm is actuated to call an operator. Thus, it is possible to prevent the number of processing sheets per unit time from being reduced, which could be caused if the state in which the event is occurrent, i.e., a state in which images can not be recorded, is continued.

As an algorithm for monitoring occurrence of the events (1) to (3), comparison between the output image data and recording image data, and comparison between a plurality of output images have been explained, but this algorithm is only an example, and just one of comparison between the output image data and recording image data and comparison between the plurality of output images could be carried out.

As the image data used for comparison with the output image data, it is possible to use image data input from the film scanner 12, or image data obtained by subjecting the image data to predetermined image processing (e.g., a simple image processing such as conversion by LUT (lookup table) or matrix calculation) instead of the recording image data. Especially, it is possible to precisely detect damage of a portion or all of the output image caused by clogging of discharge ports of nozzles of the recording head 46 using this image data.

When the original image is a film image recorded on a photo film of 135 size, it is possible to easily detect whether the recording format of the original film image is standard 135 size format or panorama size format by using this image data. Therefore, by comparing the output image data with the image data, it is possible to defect, for example, if the recording format has been erroneously detected as being 135 size standard format when the recording format of the film image is panorama size format, and a consequent failure of the image processing by the image processing apparatus 14 carrying out image processing for the 135 size standard format.

In the second embodiment, there has been explained a structure in which the recording heads 46A to 46C are reciprocated along the widthwise direction of the recording material 60 and the recording material 60 is conveyed at a constant speed along the longitudinal direction of the recording material 60, thereby recording a plurality of frame images, but the present invention is not limited to this structure. For example, as shown in FIG. 11, a plurality of recording heads 120 arranged over the entire width of the recording material 60 can be disposed at intervals from one another along the longitudinal direction of the recording material 60, and images recorded by each recording head 120 while the recording material 60 moves at a constant speed, such that a plurality of images may be concurrently recorded. In this structure, the number of discharge ports of the recording heads is greatly increased and maintenance becomes complicated but, since it is unnecessary to reciprocate the recording heads, the structure of the ink-jet printer 16 is simplified.

Further, a case in which, after N images are recorded on the recording material 60, the image recording position is cut from the nonrecorded portion of the material and this piece of the recording material 60 is conveyed has been described, but the invention is not limited to this. N image recording regions may be previously cut from the recording material 60, and N images recorded on the cut piece of the recording material 60, or N frame recording regions may be cut from the recording material 60 during the image recording operation.

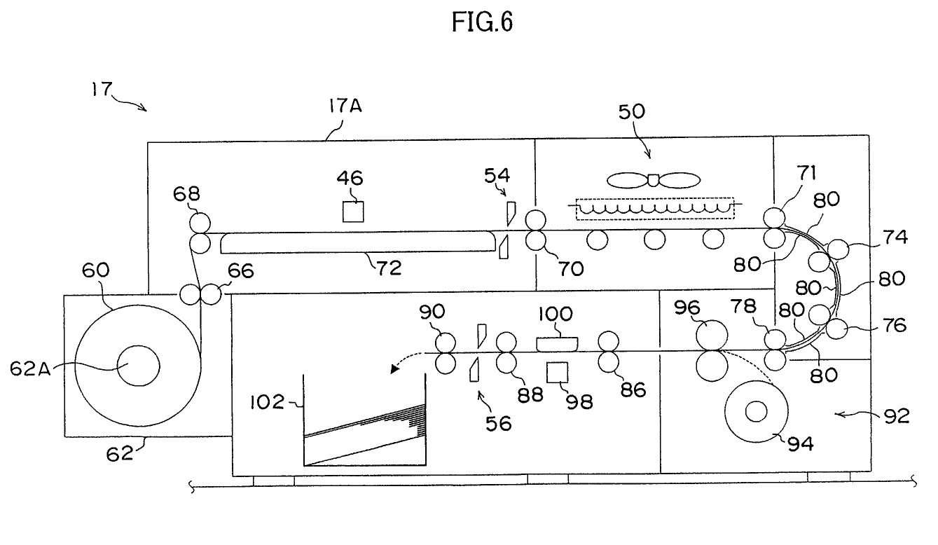

In the above description, the ink-jet printer 16 has been explained with the conveyance path 64 which reverse the conveying direction and conveys the recording material 60 downward in the substantially vertical direction after it has been conveyed upward in the substantially vertical direction. The invention is not limited to this. As in an ink-jet printer 17 shown in FIG. 6, the magazine 62 which accommodates the recording material 60 may be set to the side of a cabinet 17A, the recording material 60 conveyed in a predetermined direction substantially horizontally and then the conveying direction reversed and the recording material 60 conveyed substantially horizontally in a direction opposite to the predetermined direction. In this case, although the floor area required for installing the ink-jet printer 17 is more than for the ink-jet printer 16, it is possible to reduce the height of the cabinet 17A of the ink-jet printer 17.

As explained above, according to the present invention, a long recording material is conveyed along a conveyance path which is for conveying the recording material along the longitudinal direction of the recording material, a plurality of images are concurrently recorded on the recording material that has reached an image recording position along the longitudinal direction of the recording material, the recording material is conveyed on the conveyance path and cut into units of recording regions of a plurality of images, and the recording material on which the images has been recorded and which has been cut into unit of recording regions of a plurality of images and conveyed on the conveyance path is cut into units of recording regions of the individual images. Therefore, there are excellent effects that space required for installing the apparatus can be reduced, and a large number of images can be recorded at high speed.

In the present invention, a conveyance path may include a first conveyance path for guiding the convey of the recording material in a substantially vertical direction, a second conveyance path disposed substantially in parallel to the first conveyance path for guiding the convey of the recording material in a substantially vertical direction, and the first and second conveyance paths may be connected to each other through a reverse conveyance path. With this structure, the floor area on which the image recording apparatus is installed can be greatly reduced.

In the invention, the conveying means may pull out the recording material from a roll of recording material which is previously wound in a roll and convey the recording material. With this structure, the operability when the recording material is to be mounted to the image recording apparatus is enhanced.

In the invention, images are recorded on the recording material, the recording material is cut into units of recording regions of a plurality of images, the recording material is conveyed on the conveyance path, and predetermined post-processing is carried out before the recording material is cut into individual images. Thus, it is possible to suppress variation of processing results of the predetermined post-processing.

As the predetermined post-processing, processing for forming a transparent film on the image recording surface may be carried out. This processing enhances the waterproofing and weather resistance of the images recorded on the recording material.

As the predetermined post-processing, it is possible to carry out processing which applies thermal energy to the recording material to which the recording liquid drops have adhered by the recording means, thereby removing solvent included in the recording liquid drops. This processing prevents image quality of the recorded image from being deteriorated by the solvent being retained in the recording material.

While the recording means records the image on the recording material, monitoring means can monitor whether an event which hinders image recording operations by the recording means has occurred. If is determined that such an event has occurred, processing for removing the obstruction or event may be carried out.

The recording liquid drops are discharged from the discharge ports of the recording head, the discharged recording liquid drops are caused to adhere to the recording material to record the image on the recording material, and this operation is concurrently carried out for a plurality of recording heads disposed at different positions on the conveyance path along which the long recording material is conveyed in the longitudinal direction of the recording material, thereby recording two or more images along the longitudinal direction of the recording material, and the recording material on which the images are recorded may be cut into units of each image. Thus, it is possible to obtain a compact image recording apparatus capable of recording a large number of images at high speed.

Each recording head is reciprocated in a state in which the recording material is conveyed, the recording liquid drops are discharged from each recording head, two or more images are concurrently recorded on the recording material, and maintenance of the recording head is thus facilitated.

The recording head may include a large number of discharge ports arranged continuously from one end to the other end of the recording material in the widthwise direction of the recording material. While the recording material is conveyed, the recording liquid drops are discharged from each recording head, and two or more images are concurrently recorded on the recording material. With this structure, the apparatus structure can be simplified.

When a plurality of recording heads are provided, while the recording means is recording the images on the recording material, if the monitor means defects that an event which hinders image recording by the recording means has occurred, and it is determined that clogging of a discharge port of a certain recording head has occurred, the processing means may carry out processing to continue recording images using only recording heads in which clogging of discharge ports has not occurred. Even when clogs which are difficult to overcome are generated in the discharge ports of a recording head, it is possible to keep recording images on the recording material.

The cutting means may include first cutting means which cuts the recording material into units of two or more images and a second cutting means which cuts the recording material that has been cut and conveyed in the units of two or more images. Post-processing means may carry out at least one of: processing before the recording material, on which two or more images have been recorded and which has been cut into units of a plurality of images and conveyed on the conveyance path, is cut into units of single images by the second cutting means; and post-processing which removes solvent included in the recording liquid drops adhered to the recording material by applying thermal energy to the recording material. Thus, it is possible to uniformly carry out predetermined post-processing for the recording regions of the individual images, and it is possible to suppress variation of the results of processing.

Whit is claimed is:

1. An image recording apparatus for use with an elongated recording material, the apparatus comprising:
conveying means for conveying the recording material along a conveyance path in the longitudinal direction of the recording material;
recording means disposed on the conveyance path for concurrently recording a plurality of images onto the recording material, the images being arranged in the longitudinal direction of the recording material, the recording means including at least one recording head which includes a discharge port, drops of recording liquid being discharged from the discharge port and adhering to the recording material;
first cutting means disposed on the conveyance path for cutting the recording material into portions that each correspond to the plurality of images; and
second cutting means disposed on the conveyance path downstream from the first cutting means for cutting the portions that each correspond to the plurality of images into portions that each correspond to one of the images.

2. The apparatus of claim 1, wherein the conveyance path includes a first conveyance path, along which the recording material is guided in a substantially vertical direction, a second conveyance path substantially parallel to the first conveyance path, along which second conveyance path the recording material is guided in a substantially vertical direction, and a conveyance retroversion path communicating the first and second conveyance paths with each other for retroverting the direction of conveyance.

3. The apparatus of claim 1, wherein the recording material is in the form of a roll, and the conveying means draws the recording material from the roll.

4. The apparatus of claim 1, wherein the recording means comprises a mechanism which moves the recording head along a predetermined main scanning direction and a sub-scanning direction, which intersects the main scanning direction, relative to recording regions for the plurality of images on the recording material.

5. The apparatus of claim 1, further comprising an image reading apparatus which reads a plurality of original images and outputs image data, wherein the recording means receives the image data and records the plurality of images onto the recording material based on the image data.

6. The apparatus of claim 1, further comprising postprocessing means for performing predetermined post-processing, which is disposed on the transfer path between the first cutting means and the second cutting means.

7. The apparatus of claim 6, wherein the post-processing means forms a transparent film on an image-recording surface of the recording material.

8. The apparatus of claim 6, wherein the post-processing means applies thermal energy to the recording material for removing solvent in the drops of recording liquid adhering to the recording material.

9. The apparatus of claim 1, further comprising:
monitoring means at the conveyance path downstream from the recording means, for monitoring for occurrence of an event that hinders recording of images by the recording means; and
processing means in communication with the monitoring means and the recording means, for, when the monitoring means detects the event, implementing processing to overcome the event.

10. The apparatus of claim 1, wherein the conveying means stops conveyance of at least the recording material upstream of the first cutting means while the recording means is recording.

11. An image recording apparatus for use with an elongated recording material, the apparatus comprising:
conveying means for conveying the recording material along a conveyance path in the longitudinal direction of the recording material;
recording means disposed on the conveyance path for concurrently recording a plurality of images onto the recording material, the images being arranged in the longitudinal direction of the recording material, the recording means including a plurality of recording heads which include discharge ports, drops of recording liquid being discharged from the discharge ports and adhering to the recording material; and
cutting means disposed on the conveyance path downstream from the recording means for cutting the recording material into portions that each correspond to one of the images.

12. The apparatus of claim 11, wherein the recording means further includes moving means for reciprocating the recording heads along a widthwise direction substantially perpendicular to the conveyance path while the recording material is being conveyed by the conveying means.

13. The apparatus of claim 11, wherein each recording head extends from one side in the width direction of the recording material to the other side, the discharge ports of each recording head are arranged spaced apart in an effectively continuous manner from the one side to the other side, and the recording liquid drops are discharged while the recording material is being conveyed by the conveying means.

14. The apparatus of claim 11, further comprising an image reading apparatus which reads a plurality of original images and outputs image data, wherein the recording means receives the image data and records the plurality of images onto the recording material based on the image data.

15. The apparatus of claim 11, further comprising:
monitoring means at the conveyance path downstream from the recording means, for monitoring for occurrence of an event that hinders recording of images by the recording means; and
processing means in communication with the monitoring means and the recording means, for, when the monitoring means detects the event, implementing processing to overcome the event.

16. The apparatus of claim 15, wherein, if the event is clogging of one or more of the discharge ports of the recording heads, the processing includes causing the recording means to continue recording images using only the recording heads whose discharge ports are not clogged.

17. The apparatus of claim 11, wherein the recording material is in the form of a roll, and the conveying means draws the recording material from the roll.

18. The apparatus of claim 11, wherein the conveyance path includes a first conveyance path, along which the recording material is guided in a substantially vertical direction, a second conveyance path substantially parallel to the first conveyance path, along which second conveyance path the recording material is guided in a substantially vertical direction, and a conveyance retroversion path communicating the first and second conveyance paths with each other for retroverting the direction of conveyance.

19. The apparatus of claim 11, wherein the cutting means comprises:
first cutting means disposed on the conveyance path for cutting the recording material into portions that each correspond to the plurality of images; and
second cutting means disposed on the conveyance path downstream from the first cutting means for cutting the portions that each correspond to the plurality of images into the portions that each correspond to one of the images

20. The apparatus of claim 11, further comprising postprocessing means disposed on the conveyance path downstream of the recording means for performing at least one of forming a transparent film on an image-recording surface of the recording material and applying thermal energy to the recording material for removing solvent in the drops of recording liquid adhering to the recording material.
